(19) United States
(12) Patent Application Publication
(10) Pub. No.: US 2026/0177842 A1
(43) Pub. Date: Jun. 25, 2026

(54) EMBEDDED DIFFRACTIVE CONTACT LENSES

(71) Applicant: Alcon Inc., Fribourg (CH)

(72) Inventors: Jiakai Lyu, Shanghai (CN); David Borja, Suwanee, GA (US); Young Hyun Kim, Buford, GA (US); Myoung-Taek Choi, Arlington, TX (US); Kamal K. Das, Arlington, TX (US); Joseph Michael Lindacher, Suwanee, GA (US)

(21) Appl. No.: 19/428,669

(22) Filed: Dec. 22, 2025

Related U.S. Application Data
(60) Provisional application No. 63/738,130, filed on Dec. 23, 2024.

(51) Int. Cl. G02C 7/04

(52) U.S. Cl. CPC G02C 7/049; G02C 2202/24

(57) ABSTRACT

In some embodiments, an optical device includes a bulk silicone hydrogel material having a convex anterior surface and an opposite concave posterior surface, a central optical zone, and one or more peripheral zones circumscribing the central optical zone. The contact lens includes an insert embedded in the bulk silicone hydrogel material having a convex anterior surface and an opposite concave posterior surface, the convex anterior surface comprising 10 or more echelettes. The optical device has a convex anterior surface and an opposite concave posterior surface. The insert includes a crosslinked silicone-containing vinyl copolymer different from a crosslinked silicone-containing vinyl copolymer of the bulk silicone hydrogel material and has a diameter up to about 10 mm. The insert is concentric with a central axis of the optical device.

### FIELD

The present disclosure is directed to contact lenses configured to prevent or slow development of myopia.

### BACKGROUND

In children, a self-correcting mechanism adjusts the growth of the eye so that the light-sensitive retina is located where images of the visual world are focused (the focal plane), producing clearly focused vision (“emmetropia”). This mechanism uses visual cues to determine if the eye is too short (hyperopia) or has grown too long (myopia) relative to the focal plane and adjusts eye growth to move the retina back to emmetropia. However, this mechanism allows the eyes to become too long so they are myopic (nearsighted). Myopia is particularly prevalent for people who spend much of their time indoors. High amounts of myopia raise the risks of developing retinal holes or tears, retinal detachment, choroidal degeneration, glaucoma, cataract, and other potentially blinding conditions caused by the elongated eye. Current treatments aimed at preventing or slowing the development of myopia have achieved only modest success. For example, the economic cost of glasses, contact lenses, and refractive surgery is many millions of dollars in the U.S. alone, and these treatments thus far do not remove the risk of blindness because they do not alter the length of the eye and so the affected eye remains elongated.

Myopia predominantly develops and increases (progresses) in childhood between the ages of 5 and 15. Slowing myopia development would involve treatment throughout this extended period and thus such treatment should be safe for long-term, extended use. Companies are trying to develop effective ways to prevent children from developing myopia or to slow the rate of myopia development to reduce the final amount of myopia in adulthood. For example, low-dose atropine has been used as a pharmaceutical approach. However, besides the side effects of reducing the amplitude of accommodation and slight mydriasis, atropine dilates the pupil and increases higher order aberration and reduction of visual quality.

Attempted treatments such as prior studies related to narrow bandwidth light treatments (e.g., narrow bandwidth red light or blue light) of eyes have provided highly inconsistent results, depending on the species of animal tested and methods of treatment. In addition, the long-term effectiveness of such treatments is currently speculative. For example, a modest rebound effect has been observed upon cessation of low-level red light therapy. The same is true for cessation of pharmaceutical approaches, such as the prescription atropine treatments. In addition, for narrow bandwidth light treatment, the affected retinal region will vary with fixational eye movements during the treatment.

In addition, optical approaches have also been attempted with refractive or light scattering optical approaches finding limited efficacy. In particular, the current refractive strategies for myopia control, including ortho-keratology lenses, multisegment spectacle lenses, and dual focus design contact lenses, are based on a peripheral defocus theory where hyperopic peripheral defocus can lead to myopic growth and lenses which minimize or eliminating peripheral hyperopic defocus can prevent axial elongation. Attempts are made to change the peripheral defocus while also maintaining clear vision on the central retina. Such lenses use multifocal or non-coaxial designs to manipulate focus at the peripheral retina. Such lenses have a risk of hindering vision development for children who are undergoing the visual experience-dependent critical period of vision development for adulthood. For example, for the ortho-keratology lenses, the total higher order aberration increases after wearing the ortho-keratology lens which reduces retinal image quality.

Optical approaches, such as contact lenses, have also found limited success in treating myopia and presbyopia. Presbyopia is a disorder in which the eye loses its ability to focus at close distance, affecting more than 2 billion patients worldwide. Extensive research efforts have been contributed to develop multifocal ophthalmic lenses (intraocular lenses or contact lenses) for correcting presbyopia. Currently, multifocal diffractive intraocular lenses are commercially available for correcting presbyopia. However, multifocal diffractive contact lenses are still not commercially available for correcting presbyopia (see, Perez-Prados, et al., “Soft Multifocal Simultaneous Image Contact Lenses: Review”, Clin. Exp. Optom. 2017, 100: 107-127) due to some issues uniquely associated with contact lenses. For example, the standard lens materials have a refractive index of about 1.42 or less, i.e., about 0.04 higher than the refractive index of tear film. With such a small difference in refractive index, a higher diffraction grating height needs to be created on one of the anterior and posterior surfaces of a contact lens. However, contact lenses should have smooth anterior and posterior surfaces for wearing comfort. Such a diffraction grating causes discomfort to patients. Therefore, the step height of such diffractive structures is severely limited, hindering diffractive capability of such contact lenses.

In addition, U.S. Pat. Appl. Pub. Nos. 2021/0191153 A1, 2021/0191154A1 and 2023/0004023A1 disclose contact lenses with an embedded diffractive optical insert therein. However, there are challenges for mass production of such multifocal diffractive contact lenses. In addition to manufacturing challenges, embedded contact lenses for treatment of myopia have not found widespread success due to poor anti-myopia efficacy, pupil dependent optics, and inferior visual performance.

In addition, U.S. 2024/0272454 describes ophthalmic lenses for treatment of myopia. The ophthalmic lenses are formed by treating a lens with a laser to form a subsurface optical structure embedded in the lens. The subsurface optical structure has refractive index spatial variations relative to the lens material refractive index to provide a chromatic alteration to reduce axial growth of the eye or decrease axial length of the eye. However, laser treatments are labor intensive (e.g., require calibration, energy intensive), and such laser treatments provide lenses having imprecise and difficult to replicate final structures. There is also a likelihood that the diffractive steps created have to be very large, thus limiting design opportunities and capabilities.

An effective, safe, non-invasive, non-pharmacological treatment for myopia that could be used with ease in the course of daily life over many years would be of benefit to millions of people. In particular, there is a need for non-invasive methods to promote emmetropization and prevent or slow the development of myopia, for example, in the developing eyes of children.

### SUMMARY

The present disclosure is directed to contact lenses configured to prevent or slow development of myopia.

In some embodiments, an optical device includes a bulk silicone hydrogel material having a convex anterior surface and an opposite concave posterior surface, a central optical zone, and one or more peripheral zones circumscribing the central optical zone. The optical device includes an insert embedded in the bulk silicone hydrogel material having a convex anterior surface and an opposite concave posterior surface, the convex anterior surface comprising 10 or more echelettes. The optical device has a convex anterior surface and an opposite concave posterior surface. The insert includes a crosslinked silicone-containing vinyl copolymer different from a crosslinked silicone-containing vinyl copolymer of the bulk silicone hydrogel material and has a diameter up to about 10 mm. The insert is concentric with a central axis of the optical device. The concave posterior surface of the insert substantially aligns with the concave posterior surface of the bulk silicone hydrogel material and the convex anterior surface of the insert is embedded in and in contact with the bulk silicone hydrogel material. The crosslinked silicone-containing vinyl copolymer includes (a) repeating units of a silicone-containing aryl vinylic monomer, (b) repeating units of a silicone-containing aryl vinylic crosslinker, or (c) combinations thereof, wherein the sum of the amounts of components (a) and (b) is at least 55% by weight of the crosslinked silicone-containing vinyl copolymer. The bulk silicone hydrogel material includes (i) repeating units of a polysiloxane vinylic crosslinker, (ii) repeating units of a hydrophilic vinylic monomer, and (iii) repeating units of a polymerizable component selected from the group consisting of a silicone-containing vinylic monomer, a non-silicone hydrophobic vinylic monomer, a non-silicone vinylic crosslinker, a ultraviolet (UV)-absorbing vinylic monomer, a high energy violet light (HEVL)-absorbing vinylic monomer, a visibility tinting agent, and combinations thereof.

In some embodiments, a method for producing a contact lens, includes (1) obtaining a female insert mold half, a male lens mold half, and a female lens mold half, wherein the female insert mold half has a first molding surface defining an anterior surface of an insert to be molded and configured to provide 10 or more echelettes for an anterior surface of the insert, wherein the male lens mold half has a second molding surface defining a posterior surface of the contact lens to be molded, wherein the female lens mold half has a third molding surface defining an anterior surface of the contact lens to be molded, wherein the female insert mold half and the male lens mold half are configured to receive each other such that an insert-molding cavity is formed between the first molding surface and a central portion of the second molding surface when the female insert mold half is closed with the male lens mold half, wherein the female lens mold half and the male lens mold half are configured to receive each other such that a lens-molding cavity is formed between the third and second molding surfaces when the female lens mold half is closed with the male mold half. The method includes (2) dispensing an amount of an insert-forming composition on the first molding surface of the female insert mold half, wherein the insert-forming composition includes (i) at least one thermal free-radical initiator and (ii) (a) about 24.5% to about 75% by weight of at least one silicone-containing aryl vinylic monomer and/or (b) about 24.5% to about 75% by weight of at least one silicone-containing aryl vinylic crosslinker, relative to the total weight of all polymerizable components in the insert-forming composition, wherein the sum of the amounts of components (a) and (b) is at least 55% by weight. The method includes (3) placing the male lens mold half on top of the insert-forming composition in the female insert mold half and closing the female insert mold half and the male lens mold half to form a first molding assembly including the insert-forming composition within the insert-molding cavity. The method includes (4) thermally curing the insert-forming composition in the insert-molding cavity of the first molding assembly to form an insert including a crosslinked silicone-containing vinyl copolymer, wherein the insert includes 10 or more echelettes on an anterior surface of the insert. The method includes (5) separating the first molding assembly obtained in process (4) into the female insert mold half and the male lens mold half with the molded insert disposed on the central portion of the second molding surface. The method includes (6) dispensing a lens-forming composition in the female lens mold half in an amount sufficient for filling the lens-molding cavity, wherein the lens-forming composition includes (i) at least one free-radical photoinitiator and (ii) at least one polysiloxane vinylic crosslinker in an amount of about 35% to about 80% by weight relative to the total amount of all polymerizable components in the lens-forming composition. The method includes (7) placing the male lens mold half with the molded insert disposed thereon on top of the lens-forming composition in the female lens mold half and closing the female lens mold half and the male lens mold half to form a second molding assembly including the lens-forming composition and the insert disposed in the lens-molding cavity. The method includes (8) curing the lens-forming composition with the diffractive insert disposed therein in the lens-molding cavity of the second molding assembly to form a contact lens precursor including the silicone hydrogel material as bulk hydrogel material and the insert embedded in the silicone hydrogel material. The method includes (9) separating the second molding assembly obtained in process (8) into the female lens mold half and the male lens mold half, with the contact lens precursor adhered on a lens-adhered lens mold half which is one of the male and female lens mold halves. The method includes (10) removing the embedded diffractive contact lens precursor from the lens-adhered lens mold half. The method includes (11) subjecting the contact lens precursor to post-molding processes to obtain the contact lens.

These and other aspects of the present disclosure will become apparent from the following description of the presently described embodiments. The detailed description is merely illustrative of the present disclosure and does not limit the scope of the present disclosure, which is defined by the appended claims and equivalents thereof. As would be obvious to one skilled in the art, many variations and modifications of the embodiments herein may be effected without departing from the spirit and scope of the novel concepts of the disclosure.

### BRIEF DESCRIPTION OF DRAWINGS

FIG. 1a schematically illustrates a cross-sectional view of an embedded hydrogel contact lens, according to some embodiments.

FIG. 1b schematically illustrates a cross-sectional view of an embedded hydrogel contact lens, according to some embodiments.

FIG. 2a is a graph illustrating measured modulation transfer function (MTF) versus defocus as a measure of longitudinal chromatic aberration of an LCA-inducing contact lens utilizing an emmetropic eye model, according to some embodiments.

FIG. 2b is a graph illustrating measured optical phase in waves versus radial coordinate of an LCA-inducing contact lens, according to some embodiments.

FIG. 3 is an illustration of an emmetropic optical model eye, according to some embodiments.

FIG. 4a is a graph illustrating MTF versus defocus at the fovea of a comparative contact lens, according to some embodiments utilizing an emmetropic eye model. FIG. 4b is a graph illustrating MTF versus defocus at the peripheral retina of a comparative contact lens utilizing an emmetropic eye model, according to some embodiments. Acuvue Oasys contact lenses are made of Senofilcon A lens material and having a water content of 38% and a Dk/t of 147×10⁻⁹. Proclear from CooperVision is made of Omafilcon A.

FIG. 5a is a graph illustrating MTF versus defocus at the fovea of a comparative contact lens utilizing an emmetropic eye model, according to some embodiments. FIG. 5b is a graph illustrating MTF versus defocus at the peripheral retina of a comparative contact lens utilizing an emmetropic eye model, according to some embodiments. Acuvue Abiliti contact lenses are made of Senofilcon A and have treatment zones used to reshape the cornea's curvature and focus light onto the retina. These lenses have a Dk/t value of 121×10⁻⁹.

FIG. 6a is a graph illustrating MTF versus defocus at the fovea of an inventive contact lens utilizing an emmetropic eye model, according to some embodiments.

FIG. 6b is a graph illustrating MTF versus defocus at the peripheral retina of an inventive contact lens utilizing an emmetropic eye model, according to some embodiments.

FIG. 7a is a graph illustrating MTF versus defocus at the fovea of an inventive contact lens utilizing an emmetropic eye model, according to some embodiments.

FIG. 7b is a graph illustrating MTF versus defocus at the peripheral retina of an inventive contact lens utilizing an emmetropic eye model, according to some embodiments.

FIG. 8a shows two graphs, each illustrating a simulated diffractive profile of an inventive contact lens, according to some embodiments.

FIG. 8b shows two graphs, each illustrating input axial power of an inventive contact lens, according to some embodiments.

FIG. 9 is a graph illustrating a myopic eye model, according to some embodiments. The data points are based on a literature review of published relative refraction data. The model of the peripheral retina was re-defined based on available literature data for low myopes (less than −5 D). The model eye also incorporates spherical aberration of 0.9 D @5 mm pupil size. Retinal eccentricity of 10 degrees has a relative hyperopic refraction of 0.120 D, and retinal eccentricity of 20 degrees has a relative hyperopic refraction of 0.377 D.

FIG. 10a is a graph illustrating MTF area under the curve (MTFa) (from 0 to 100 lp/mm) versus defocus at the fovea of an eye with no lens utilizing the myopic eye model, according to some embodiments. FIG. 10b is a graph illustrating MTF at 25 lp/mm versus defocus of an eye with no lens at 10 degrees and utilizing the myopic eye model, according to some embodiments. FIG. 10c is a graph illustrating MTF at 25 lp/mm versus defocus of an eye with no lens at 20 degrees and utilizing the myopic eye model, according to some embodiments.

FIG. 11a is a graph illustrating MTFa versus defocus at the fovea of a contact lens utilizing LCA only (no peripheral add) and utilizing the myopic eye model, according to some embodiments. FIG. 11b is a graph illustrating MTF at 25 lp/mm versus defocus of a contact lens utilizing LCA only and at 10 degrees and utilizing the myopic eye model, according to some embodiments. FIG. 11c is a graph illustrating MTF at 25 lp/mm versus defocus of a contact lens utilizing LCA only and at 20 degrees and utilizing the myopic eye model, according to some embodiments.

FIG. 12a is a graph illustrating MTFa versus defocus at the fovea of a contact lens utilizing LCA plus peripheral add power and utilizing the myopic eye model, according to some embodiments. FIG. 12b is a graph illustrating MTF at 25 lp/mm versus defocus of a contact lens utilizing LCA plus peripheral add power and at 10 degrees and utilizing the myopic eye model, according to some embodiments. FIG. 12c is a graph illustrating MTF at 25 lp/mm versus defocus of a contact lens utilizing LCA plus peripheral add power and at 20 degrees and utilizing the myopic eye model, according to some embodiments.

FIG. 13a is a graph illustrating MTFa versus defocus at the fovea of an eye with no lens utilizing the myopic eye model, according to some embodiments. FIG. 13b is a graph illustrating MTF at 25 lp/mm versus defocus of an eye with no lens at 10 degrees and utilizing the myopic eye model, according to some embodiments. FIG. 13c is a graph illustrating MTF at 25 lp/mm versus defocus of an eye with no lens at 20 degrees and utilizing the myopic eye model, according to some embodiments.

FIG. 14a is a graph illustrating MTFa versus defocus at the fovea of a contact lens utilizing LCA only (no peripheral add) and utilizing the myopic eye model, according to some embodiments. FIG. 14b is a graph illustrating MTF at 25 lp/mm versus defocus of a contact lens utilizing LCA only and at 10 degrees and utilizing the myopic eye model, according to some embodiments. FIG. 14c is a graph illustrating MTF at 25 lp/mm versus defocus of a contact lens utilizing LCA only and at 20 degrees and utilizing the myopic eye model, according to some embodiments.

FIG. 15a is a graph illustrating MTFa versus defocus at the fovea of a contact lens utilizing LCA plus peripheral add power and utilizing the myopic eye model, according to some embodiments. FIG. 15b is a graph illustrating MTF at 25 lp/mm versus defocus of a contact lens utilizing LCA plus peripheral add power and at 10 degrees and utilizing the myopic eye model, according to some embodiments. FIG. 15c is a graph illustrating MTF at 25 lp/mm versus defocus of a contact lens utilizing LCA plus peripheral add power and at 20 degrees and utilizing the myopic eye model, according to some embodiments.

### DETAILED DESCRIPTION OF EMBODIMENTS

The present disclosure is directed to contact lenses configured to prevent or slow development of myopia. Contact lenses of the present disclosure have (1) a refractive anterior surface capable of providing peripheral myopic defocus and (2) an embedded monofocal diffractive insert capable of providing positive dispersion of light. The unique combination of features of contact lenses of the present disclosure promotes sending most of the received light to substantially a singular distance (e.g., near) and then corrects the power with the overall cycle of the lens. The unique combination of features slows or inhibits the progression of myopia in patients, such as children during vision development (e.g., children undergoing the visual experience-dependent critical period of vision development for adulthood).

The step height of the steps/rings diffractive structure can be determined based on the refractive index of the insert materials to ensure monofocality of the insert rather than multifocality. For example, the number of steps/rings can be about 10 to about 40, correlating with the amount of longitudinal chromatic aberration (LCA) induced and the pupil size of the wearer. When LCA is increased, the central fovea focuses more on green to red wavelengths, to which human eyes are highly sensitive, while the peripheral retina focuses red light and myopically defocused blue light due to the impact of peripheral add power. This results in reduced blue contrast and heightened red contrast in the periphery. In addition, minimal ring spacing results in higher dioptric power provided by the diffractive insert. The number of rings ensures appropriate sizing for different pupil sizes, with constant step height across the varying numbers of steps/rings and ring spacing. Step heights can be altered when different lens materials are used to control energy distribution, achieving monofocality. Depending on the lens materials' refractive indices, the shape of the each diffractive step could be concave or convex.

The peripheral add power aims to focus light differently on the peripheral retina compared to the central retina using diffractive positive dispersion. The peripheral add power causes all wavelengths of light to be defocused peripherally. The effect of peripheral add power targets the retina at approximately 7 degrees to about 20-30 degrees from the central fovea. This method aims to achieve blue contrast reduction and high red contrast in the periphery, along with myopia defocus blue light on the peripheral retina.

The unique combination of features of contact lenses of the present disclosure also allows a wide range of diopters (e.g., +5 D or higher) that may be used in peripheral zone(s) of the bulk material of the lens that provide the peripheral myopic defocus. Since the peripheral add power utilized is to peripherally defocus light, the peripheral add design can be changed to have less visual impairment while the overall contact lens having the insert targets higher myopia-control efficacy than existing peripheral add/scattering optics. In the fovea, the diffractive LCA is able to further defocus the blue (lower contrast) while maintaining focus on green red. However, this may not be the case in the peripheral retina based upon simulations. In order to ensure that this reduction in blue contrast happens in the periphery too, having peripheral add power promotes the reduction in blue contrast. Such embodiments allow sphero-cylindrical refractive correction and independent control of chromatic aberration.

As an example, a refractive outer surface of a contact lens can have a central optical zone and one or more peripheral zones circumscribing the central optical zone. The one or more peripheral zones can have a dioptric power different from the dioptric power of the central optical zone, which can collectively provide peripheral myopic defocus in the eye of a user. The defocus can defocus all wavelengths of visible light (e.g., 380 nm to 550 nm, such as 400 nm to 500 nm, and 500 nm to 700 nm). In such embodiments, the peripheral zone(s) provide a reduced contrast zone where a clinically significant reduction in contrast compared to the contrast of the first (central) zone is provided (reduction from ideal diffraction limit of the first zone). In doing so, the overall contrast of the blue light can be significantly reduced while maintaining high red/green contrast. In addition, a diffractive, monofocal insert can have 10 or more rings/steps, where a plurality of the steps/rings each has a step height independently of about 8 μm to about 20 μm, such as about 8 μm to about 12 μm, alternatively about 12 μm to about 16 μm, alternatively about 16 μm to about 20 μm (however, other step heights can be utilized depending on refractive index of the lens materials used), the rings/steps surrounding a central, concave optical zone, and the ring/steps each having an outward increasing slope toward the periphery of the lens followed by a sharp drop off to provide the step height. By providing rings/steps as part of the insert rather than on the lens (bulk material) surfaces, the anterior and posterior surfaces of the lens remain smooth, protecting the cornea and tear film from scratches and patient discomfort. The structure of the diffractive insert creates monofocality and strong longitudinal chromatic aberration by positive dispersion of light. Such a kinoform structure provides blue light focused nearer to the front of the eye, followed by green light, then followed by red light. In this way, the chromatic aberration induced by the lens enhances the chromatic aberration of the human eye. In contrast, prior contact lenses have sought to reduce/eliminate longitudinal chromatic aberration because correcting LCA will give higher visual acuity, whereas lenses of the present disclosure are configured to promote increased longitudinal chromatic aberration. The area of each ring collectively dictates the dioptric power of the insert, and the height of the steps determines the relative amount of energy that goes into each focus, with taller step heights providing more energy into each focus. In addition, the number of rings determines how much of the pupil is covered, such as substantial or entire coverage of the pupil by the diffractive insert. In some embodiments, step heights of rings/steps decrease or are substantially uniform from the center of the insert toward the periphery of the insert. Substantially uniform step heights can send the received light to one distance (e.g., near) to promote monofocality.

Anti-myopia benefits provided by contact lenses of the present disclosure can be realized by the lenses providing a broadened/increased longitudinal chromatic aberration of light in an eye of the user, as compared to conventional contact lenses (e.g., as shown in the Figures). Interestingly, the broadened/increased longitudinal chromatic aberration does not meaningfully impact on-axis image quality, depending where the peripheral add zone starts. In some embodiments, the longitudinal chromatic aberration can be about 0.5 D to about 8 D, about 1 D to about 3 D, such as about 1.4 D to about 2.6 D, such as about 1.5 D to about 2 D, alternatively about 2 D to about 2.5 D (e.g., depending on the spacing of rings of the diffractive insert where less spacings increase longitudinal chromatic aberration), defined from 450 nm wavelength (blue) to 650 nm wavelength (red). The combination of broadened longitudinal chromatic aberration in addition to peripheral defocus gives the eye a very strong signal that the eye periphery is myopic and axial elongation of the eye will slow or stop.

In addition, manufacturing methods of lenses of the present disclosure also have scalability without a need to fully encapsulate the insert and without decreased quality of the lenses, e.g., delamination or swelling of the insert.

In general, outdoor lighting, and most indoor lighting, contains many wavelengths. The eye focuses different wavelengths (colors) of light (long wavelength/red, and short wavelength/blue) at different distances behind the cornea. Blue wavelengths are in focus nearer the cornea than are red wavelengths, a property referred to herein as longitudinal chromatic aberration (LCA). Without being bound by theory, LCA is not specifically directed to “defocus”; rather, LCA is directed to changes in the image contrast across the retinal surface that is produced by defocus. Due to LCA, long wavelengths focus further away behind the retina than shorter wavelengths which are focused in front of the retina. However, contact lenses of the present disclosure provide both broadened LCA and peripheral defocus.

The emmetropization mechanism evolved and normally operates in broadband (“white”) light where all wavelengths are present across the visible spectrum (400-700 nm). In broadband light, many cues are present in a defocused image that potentially can provide the drive that generates retinal signals used to modulate axial elongation of the eye. For example, in a defocused eye, image contrast on the retina is reduced. The retinal image produced by a sharp light-dark edge becomes a more gradual change from higher to lower illuminance across the retina. Other cues, such as high spatial frequencies, higher order-aberrations (astigmatism, coma, etc.) and other possible cues are also altered. The specific optical cues used by the emmetropization mechanism share the basic premise that the retina doesn't specifically detect “defocus”; rather it detects changes in the “image statistics” (such as image contrast) across the retinal surface that are produced by defocus.

Vertebrate eyes have significant LCA: long wavelengths focus farther away from the cornea than do shorter wavelengths. Therefore, when longer wavelengths are in better relative focus than shorter wavelengths (an indication that the eye is longer than optimal), this may provide a signal that the eye is too long and generate retinal signals that restrain axial elongation. If shorter wavelengths are in better focus than long wavelengths, this may lead to retinal signals that increase axial elongation.

If LCA cues are important, removing them should impair the ability of the emmetropization mechanism to function. Although there is a high degree of variability in the results of these studies by species and the specific wavelengths used, evidence indicates that emmetropization is disrupted in narrow bandwidth light in tree shrews, non-human primates, chicks, guinea pigs and mice. Studies suggest that the LCA cues present in broadband lighting conditions are not only important for normal operation of the emmetropization mechanism, but also are essential for it to function properly. When LCA cues are removed, the emmetropization mechanism is unable to utilize other, remaining, defocus-related cues to maintain or achieve emmetropia. Accordingly, lenses of the present disclosure are beneficial that utilize a peripheral defocus mechanism (in addition to positive dispersion using diffractive optics) and are able to broaden the LCA.

In addition, two arrays of cone photoreceptors (short wavelength sensitive cones or long wavelength sensitive cones) are present on the retina and independently detect “image sharpness” and have opponent effects on axial growth of the eye. If the SWS cone array detects sharper images on the retina than the LWS system, post-receptoral retinal circuitry then signals for increased axial growth (a positive drive). If the LWS cone array detects relatively sharper images on the retina, the post-receptoral circuitry then signals for slower axial growth (a negative drive). Accordingly, lenses of the present disclosure that utilize the defocus mechanism to defocus blue wavelengths of light and reduce blue contrast (in addition to positive dispersion using a monofocal insert) provide anti-myopic benefits. For example, it is believed such embodiments may be interpreted by the retina as the eye having too long of an axial length and the eye should stop growing (anti-myopiagenic).

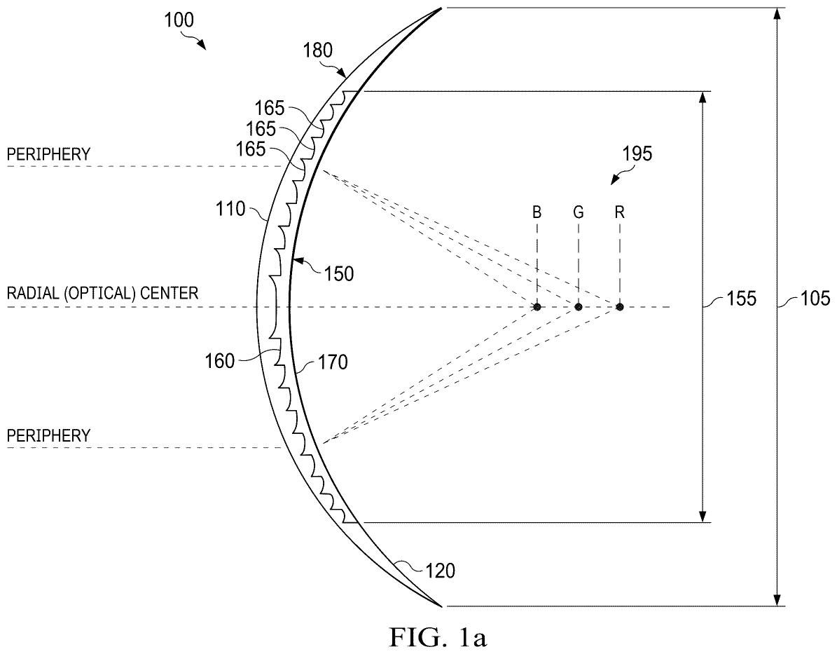

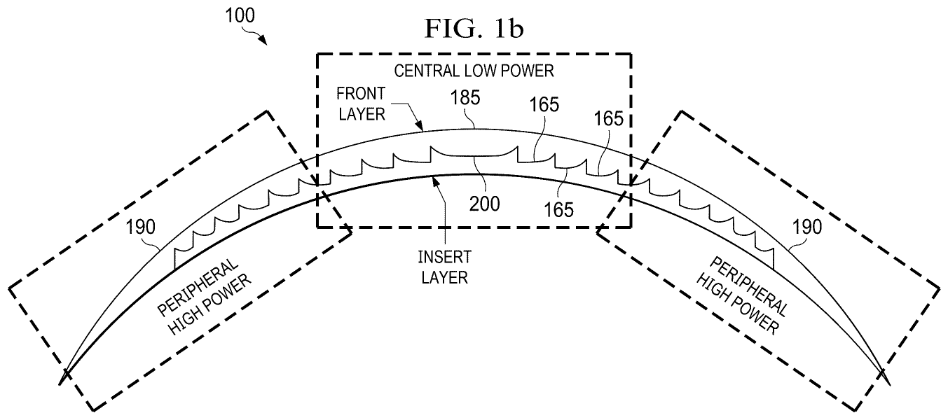

FIGS. 1a and 1b schematically illustrate a cross-sectional view of an embedded hydrogel contact lens 100, according to some embodiments. Embedded hydrogel contact lens 100 includes an anterior surface 110, an opposite posterior surface 120, and an insert 150. The contact lens 100 has a diameter 105 large enough to cover the cornea of a human eye. The insert 150 includes a polymeric material different from the polymeric material of the remaining part (the bulk material 180) of the embedded hydrogel contact lens 100 and includes an anterior surface 160 and an opposite posterior surface 170. The insert 150 has a diameter 155 sufficiently small so as to be located within the optical zone of the embedded hydrogel contact lens 100. In some embodiments, diameter 155 is about 6 mm to about 9 mm, such as about 6 mm to about 7 mm, alternatively about 7 mm to about 8 mm, alternatively about 8 mm to about 9 mm. According to such embodiments, the posterior surface 170 of the insert 150 has a curvature substantially identical to the curvature of the posterior surface 120 of the embedded hydrogel contact lens 100 and can be substantially merged with the posterior surface 120 of the bulk material 180 of the embedded contact lens 100.

Anterior surface 110 of contact lens 100 has a central optical zone 185 and one or more peripheral zones 190 circumscribing the central optical zone. The one or more peripheral zones 190 have a dioptric power different from the dioptric power of the central optical zone 185, which can collectively provide peripheral myopic defocus in the eye of a user. The insert 150 has a plurality of rings 165 (also referred to herein as steps or echelettes), where the plurality 165 of the steps/rings each has a step height. The rings/steps 165 partially or completely surrounding a central concave portion 200 of insert 150. The central concave portion 200 is disposed within the central optical zone 185. The ring/steps 165 each have an outward increasing slope toward the periphery of the lens 100 followed by a sharp drop off to provide step height. During use by a wearer, the structure of the diffractive insert 150 creates monofocality and an increased longitudinal chromatic aberration 195 by positive dispersion of light. Such a kinoform structure provides blue light (B) focused nearer to the front of the eye, followed by green light (G), then followed by red light (R).

### Diffractive Insert Portion of Contact Lenses

A diffractive insert can be formulated by any suitable crosslinked silicone-containing vinyl copolymer. To form a diffractive insert (e.g., insert 150 of FIGS. 1a-1b), an insert-forming composition is used. An insert-forming composition can be any polymerizable composition. The crosslinked silicone-containing vinyl copolymers or silicone-hydrogels resulted therefrom may have a refractive index that is at least 0.03 higher than the refractive index of the bulk silicone hydrogel material (e.g., bulk material 180 of FIGS. 1a-1b).

In various embodiments, the crosslinked silicone-containing vinyl copolymer of the insert has a refractive index of at least 1.44, (such as at least 1.46, such as at least 1.48, such as at least 1.50), an oxygen permeability of at least 30 barrers (such as at least 40 barrers, such as at least 55 barrers, such as at least 70 barrers, such as about 30 barrers to about 160 barrers), an elastic modulus of about 15.0 MPa or lower (such as about 10.0 MPa or lower, such as about 6.0 MPa or lower, such as about 4.0 MPa or lower), or combinations thereof.

In addition to parabolic shapes, the central/inner echelette (e.g., 200 of FIGS. 1a-1b) can have any of a variety of shapes including hyperbolic, spherical, aspheric, biconic, or sinusoidal. The transition between the inner and outer portions of the central/inner echelette can be a sharp transition, or it can be a smooth transition.

The insert has about 10 or more echelettes (the central echelette plus peripheral echelettes circumscribing the central echelette), such as about 20 or more echelettes, such as about 20 to about 40 echelettes, such as about 22 to about 30 echelettes, such as about 22 to about 25 echelettes, alternatively about 25 echelettes to about 35 echelettes, such as about 30 echelettes to about 35 echelettes. The central echelette can have a surface area of about 0.3 mm² to about 3 mm², and each peripheral echelette can independently have a surface area of about 0.3 mm² to about 1 mm². Each echelette independently has a step height of about 1 μm to about 20 μm, such as about 5 μm to about 18 μm, such as about 8 μm to about 15 μm, such as about 9 μm to about 12 μm. In some embodiments, the insert has a dioptric power of about −3 D to about 3 D, such as about −1 D to about 1 D, such as about 0 D, alternatively about −1 D to about −10 D, such as about −3 D to about −5 D.

In some embodiments, spacing between adjacent steps (peak-to-peak spacing) can be utilized to promote how much longitudinal chromatic aberration is induced. In some embodiments, spacing between adjacent steps decreases from the center of the insert toward the periphery of the insert. For example, the central echelette/step of the insert can have a radius of about 0.3 mm to about 0.8 mm, such as about 0.4 mm to about 0.7 mm, such as about 0.4 mm to about 0.5 mm, alternatively about 0.5 mm to about 0.6 mm, alternatively about 0.6 mm to about 0.7 mm. Spacing (peak-to-peak) between the first step and the second step can be about 0.18 mm to about 0.2 mm (e.g., for 2.4 D LCA), about 0.2 mm to about 0.22 mm (e.g., for 1.9 D LCA), or about 0.24 mm to about 0.26 mm (e.g., for 1.4 D LCA). Spacing (peak-to-peak) between the second step and the third step can be about 0.14 mm to about 0.16 mm (e.g., for 2.4 D LCA), about 0.16 mm to about 0.18 mm (e.g., for 1.9 D LCA), or about 0.18 mm to about 0.2 mm (e.g., for 1.4 D LCA). Spacing (peak-to-peak) between the third step and the fourth step can be about 0.12 mm to about 0.14 mm (e.g., for 2.4 D LCA), about 0.13 mm to about 0.15 mm (e.g., for 1.9 D LCA), or about 0.15 mm to about 0.17 mm (e.g., for 1.4 D LCA). Spacing (peak-to-peak) between the fourth step and the fifth step can be about 0.1 mm to about 0.12 mm (e.g., for 2.4 D LCA), about 0.12 mm to about 0.14 mm (e.g., for 1.9 D LCA), or about 0.14 mm to about 0.15 mm (e.g., for 1.4 D LCA). Spacing (peak-to-peak) between the fifth step and the sixth step can be about 0.09 mm to about 0.11 mm (e.g., for 2.4 D LCA), about 0.1 mm to about 0.12 mm (e.g., for 1.9 D LCA), or about 0.12 mm to about 0.14 mm (e.g., for 1.4 D LCA). Spacing (peak-to-peak) between the sixth step and the seventh step can be about 0.08 mm to about 0.1 mm (e.g., for 2.4 D LCA), about 0.09 mm to about 0.11 mm (e.g., for 1.9 D LCA), or about 0.11 mm to about 0.13 mm (e.g., for 1.4 D LCA). Spacing (peak-to-peak) between the seventh step and the eighth step can be about 0.08 mm to about 0.1 mm (e.g., for 2.4 D LCA), about 0.09 mm to about 0.11 mm (e.g., for 1.9 D LCA), or about 0.1 mm to about 0.12 mm (e.g., for 1.4 D LCA). Spacing (peak-to-peak) between the eighth step and the ninth step can be about 0.07 mm to about 0.09 mm (e.g., for 2.4 D LCA), about 0.08 mm to about 0.1 mm (e.g., for 1.9 D LCA), or about 0.09 mm to about 0.11 mm (e.g., for 1.4 D LCA). Spacing (peak-to-peak) between the ninth step and the tenth step can be about 0.07 mm to about 0.09 mm (e.g., for 2.4 D LCA), about 0.08 mm to about 0.1 mm (e.g., for 1.9 D LCA), or about 0.09 mm to about 0.11 mm (e.g., for 1.4 D LCA). Spacing (peak-to-peak) between the tenth step and the eleventh step can be about 0.07 mm to about 0.09 mm (e.g., for 2.4 D LCA), about 0.08 mm to about 0.1 mm (e.g., for 1.9 D LCA), or about 0.09 mm to about 0.11 mm (e.g., for 1.4 D LCA). Spacing (peak-to-peak) between the eleventh step and the twelfth step can be about 0.06 mm to about 0.08 mm (e.g., for 2.4 D LCA), about 0.07 mm to about 0.09 mm (e.g., for 1.9 D LCA), or about 0.08 mm to about 0.1 mm (e.g., for 1.4 D LCA). Spacing (peak-to-peak) between the twelfth step and the thirteenth step can be about 0.06 mm to about 0.08 mm (e.g., for 2.4 D LCA), about 0.07 mm to about 0.09 mm (e.g., for 1.9 D LCA), or about 0.08 mm to about 0.1 mm (e.g., for 1.4 D LCA). Spacing (peak-to-peak) between the thirteenth step and the fourteenth step can be about 0.06 mm to about 0.08 mm (e.g., for 2.4 D LCA), about 0.07 mm to about 0.09 mm (e.g., for 1.9 D LCA), or about 0.08 mm to about 0.1 mm (e.g., for 1.4 D LCA). Spacing (peak-to-peak) between the fourteenth step and the fifteenth step can be about 0.06 mm to about 0.08 mm (e.g., for 2.4 D LCA), about 0.06 mm to about 0.08 mm (e.g., for 1.9 D LCA), or about 0.08 mm to about 0.1 mm (e.g., for 1.4 D LCA). Spacing (peak-to-peak) between the fifteenth step and the sixteenth step can be about 0.05 mm to about 0.07 mm (e.g., for 2.4 D LCA), about 0.06 mm to about 0.08 mm (e.g., for 1.9 D LCA), or about 0.07 mm to about 0.09 mm (e.g., for 1.4 D LCA). Spacing (peak-to-peak) between the sixteenth step and the seventeenth step can be about 0.05 mm to about 0.07 mm (e.g., for 2.4 D LCA), about 0.06 mm to about 0.08 mm (e.g., for 1.9 D LCA), or about 0.07 mm to about 0.09 mm (e.g., for 1.4 D LCA). Spacing (peak-to-peak) between the seventeenth step and the eighteenth step can be about 0.05 mm to about 0.07 mm (e.g., for 2.4 D LCA), about 0.06 mm to about 0.08 mm (e.g., for 1.9 D LCA), or about 0.07 mm to about 0.09 mm (e.g., for 1.4 D LCA). Spacing (peak-to-peak) between the eighteenth step and the nineteenth step can be about 0.05 mm to about 0.07 mm (e.g., for 2.4 D LCA), about 0.06 mm to about 0.08 mm (e.g., for 1.9 D LCA), or about 0.07 mm to about 0.09 mm (e.g., for 1.4 D LCA). Spacing (peak-to-peak) between the nineteenth step and the twentieth step can be about 0.05 mm to about 0.07 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twentieth step and the twenty first step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty first step and the twenty second step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty second step and the twenty third step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty third step and the twenty fourth step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty fourth step and the twenty fifth step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty fifth step and the twenty sixth step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty sixth step and the twenty seventh step can be about 0.04 mm to about 0.06 mm (e.g., for 2.4 D LCA), about 0.05 mm to about 0.07 mm (e.g., for 1.9 D LCA), or about 0.06 mm to about 0.08 mm (e.g., for 1.4 D LCA). Spacing (peak-to-peak) between the twenty seventh step and the twenty eighth step can be about 0.04 mm to about 0.06 mm (e.g., for 2.4 D LCA) or about 0.04 mm to about 0.06 mm (e.g., for 1.9 D LCA). Spacing (peak-to-peak) between the twenty eighth step and the twenty ninth step can be about 0.04 mm to about 0.06 mm (e.g., for 2.4 D LCA) or about 0.04 mm to about 0.06 mm (e.g., for 1.9 D LCA). Spacing (peak-to-peak) between the twenty ninth step and the thirtieth step can be about 0.04 mm to about 0.06 mm (e.g., for 2.4 D LCA) or about 0.04 mm to about 0.06 mm (e.g., for 1.9 D LCA). Spacing (peak-to-peak) between the thirtieth step and the thirty first step can be about 0.04 mm to about 0.06 mm (e.g., for 2.4 D LCA) or about 0.04 mm to about 0.06 mm (e.g., for 1.9 D LCA). Spacing (peak-to-peak) between subsequent steps (e.g., the thirty first step and the thirty second step, the thirty second step and the thirty third step, the thirty third step and thirty fourth step) can be about 0.03 mm to about 0.05 mm (e.g., for 2.4 D LCA). The number of steps utilized on a diffractive insert can depend on how big of an optical zone to cover is desired (more steps can provide more optical zone covered. But this can be a tradeoff to having more visual disturbance). For example, 34 rings for 2.4 D LCA covering 5.57 mm diameter can be used, but 30 rings for 2.4 D LCA to cover 5.22 mm diameter instead can also be used.

In addition, by including at least one silicone-containing aryl-containing polymerizable component in an amount of at least 55% (such as at least 60%, such as at least 65%, such as at least 70%, such as at least 75%) by weight relative to the total weight of all polymerizable components, such an insert-forming composition can form a crosslinked silicone-rich material having not only a relatively high oxygen permeability that provides corneal health but also a relatively higher refractive index for creating a diffractive optics structure on one of the surfaces of the insert which is fully embedded within the bulk SiHy material.

Any silicone-containing aryl vinylic monomers as some of said at least one silicone-containing aryl-containing polymerizable component can be used. Examples of silicone-containing aryl vinylic monomers include silicone-containing aryl vinylic monomers (e.g., p-vinylphenyltris(trimethylsiloxy)silane, m-vinylphenyl-tris(trimethyl-siloxy)silane, o-vinylphenyltris(trimethylsiloxy)silane, p-styrylethyl-tris(trimethylsiloxy)silane, m-styrylethyl-tris(trimethylsiloxy)silane, o-styrylethyl-tris(trimethylsiloxy)silane), and combinations thereof.

Any silicone-containing aryl vinylic crosslinkers as others of said at least one silicone-containing aryl-containing polymerizable component can be used. Examples of silicone-containing aryl vinylic crosslinkers include aryl-containing polysiloxane vinylic crosslinkers each of which includes: (1) a polydiorganosiloxane segment including dimethylsiloxane units and aryl-containing siloxane units each having at least one aryl-containing substituent having up to 45 carbon atoms; and (2) ethylenically-unsaturated groups (such as (meth)acryloyl groups). In some embodiments, the polydiorganosiloxane segment includes at least 25% by mole of the aryl-containing siloxane units. The aryl-containing polysiloxane vinylic crosslinkers can have a number average molecular weight of at least 1000 Daltons (such as 1500 Daltons to 100000 Daltons, such as 2000 to 80000 Daltons, such as 2500 to 60000 Daltons).

Examples of such aryl-containing polysiloxane vinylic crosslinkers include vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), (meth)acryloxyalkyl-terminated polyphenylmethysiloxanes, (meth)acryloxyalkyl-terminated phenylmethyl-vinylphenylsiloxane copolymers, (meth)acryloxyalkyl-terminated diphenylsiloxane-dimethylsiloxane copolymers, ethylenically-unsaturated group-terminated dimethylsiloxane-arylmethylsiloxane copolymers disclosed in U.S. Pat. Appl. Pub. No. 2022/00306810, or combinations thereof.

An insert-forming composition can further include at least one non-silicone aryl vinylic monomer and/or at least one non-silicone aryl vinylic crosslinker. Non-silicone aryl vinylic monomers and non-silicone aryl vinylic crosslinkers can provide resultant insert with an enhanced refractive index.

Examples of non-silicone aryl vinylic monomers include: N-phenyl (meth)acrylamide; N-(4-methylphenyl) (meth)acrylamide; N-(benzyl) (meth)acrylamide; N-(2-phenylethyl) (meth)acrylamide; N-(3-chloro-4-methylphenyl) (meth)acrylamide; N-(4-hydroxyphenyl) (meth)acrylamide; N-(4-nitrophenyl) (meth)acrylamide; N-(4-phenoxyphenyl) (meth)acrylamide; 2-ethylphenoxy acrylate; 2-ethylphenoxy methacrylate; phenyl acrylate; phenyl methacrylate; benzyl acrylate; benzyl methacrylate; 2-phenylethyl acrylate; 2-phenylethyl methacrylate; 3-phenylpropyl acrylate; 3-phenylpropyl methacrylate; 4-phenylbutyl acrylate; 4-phenylbutyl methacrylate; 4-methylphenyl acrylate; 4-methylphenyl methacrylate; 4-methylbenzyl acrylate; 4-methylbenzyl methacrylate; 2-(2-methylphenyl)ethyl acrylate; 2-(2-methylphenyl)ethyl methacrylate; 2-(3-methylphenyl)ethyl acrylate; 2-(3-methylphenyl)ethyl methacrylate; 2-(4-methylphenyl)ethyl acrylate; 2-(4-methylphenyl)ethyl methacrylate; 2-(4-propylphenyl)ethyl acrylate; 2-(4-propylphenyl)ethyl methacrylate; 2-(4-(1-methylethyl)phenyl)-ethyl acrylate; 2-(4-(1-methylethyl)phenyl)ethyl methacrylate; 2-(4-methoxyphenyl)ethyl acrylate; 2-(4-methoxy-phenyl)ethyl methacrylate; 2-(4-cyclohexylphenyl)ethyl acrylate; 2-(4-cyclohexylphenyl)ethyl methacrylate; 2-(2-chlorophenyl)ethyl acrylate; 2-(2-chlorophenyl)ethyl methacrylate; 2-(3-chlorophenyl)ethyl acrylate; 2-(3-chlorophenyl)ethyl methacrylate; 2-(4-chlorophenyl)ethyl acrylate; 2-(4-chlorophenyl)ethyl methacrylate; 2-(4-bromophenyl)ethyl acrylate; 2-(4-bromophenyl)ethyl methacrylate; 2-(3-phenylphenyl)ethyl acrylate; 2-(3-phenylphenyl)ethyl methacrylate; 2-(4-phenylphenyl)ethyl acrylate; 2-(4-phenylphenyl)ethyl methacrylate; 2-(4-benzylphenyl)ethyl acrylate; 2-(4-benzylphenyl)ethyl methacrylate; 2-(phenylthio)ethyl acrylate; 2-(phenylthio)ethyl methacrylate; 2-benzyloxyethyl acrylate; 3-benzyloxypropyl acrylate; 2-benzyloxyethyl methacrylate; 3-benzyloxypropyl methacrylate; 2-[2-(benzyloxy)ethoxy]ethyl acrylate; 2-[2-(benzyloxy)ethoxy]ethyl methacrylate; aryl-containing ene monomers; or combinations thereof. The above listed aryl acrylic monomers can be obtained from commercial sources or alternatively prepared according to methods known in the art.

Examples of aryl-containing ene monomers include vinyl naphthalenes, vinyl anthracenes, vinyl phenanthrenes, vinyl pyrenes, vinyl biphenyls, vinyl terphenyls, vinyl phenyl naphthalenes, vinyl phenyl anthracenes, vinyl phenyl phenanthrenes, vinyl phenyl pyrenes, vinyl phenyl terphenyls, phenoxy styrenes, phenyl carbonyl styrenes, phenyl carboxy styrenes, phenoxy carbonyl styrenes, allyl naphthalenes, allyl anthracenes, allyl phenanthrenes, allyl pyrenes, allyl biphenyls, allyl terphenyls, allyl phenyl naphthalenes, allyl phenyl anthracenes, allyl phenyl phenanthrenes, allyl phenyl pyrenes, allyl phenyl terphenyls, allyl phenoxy benzenes, allyl(phenylcarbonyl)benzenes, allyl phenoxy benzenes, allyl(phenyl carbonyl)benzenes, allyl(phenylcarboxy)benzenes, and allyl(phenoxy carbonyl)benzenes.

Examples of aryl-containing ene monomers include styrene, 2,5-dimethylstyrene, 2-(trifluoromethyl)styrene, 2-chlorostyrene, 3,4-dimethoxystyrene, 3-chlorostyrene, 3-bromostyrene, 3-vinylanisole, 3-methylstyrene, 4-bromostyrene, 4-tert-butylstyrene, 2,3,4,5,6-pentanfluorostyrene, 2,4-dimethylstyrene, 1-methoxy-4-vinylbenzene, 1-chloro-4-vinylbenzene, 1-methyl-4-vinylbenzene, 1-(chloromethyl)-4-vinylbenzene, 1-(bromomethyl)-4-vinylbenzene, 3-nitrostyrene, 1,2-vinyl phenyl benzene, 1,3-vinyl phenyl benzene, 1,4-vinyl phenyl benzene, 4-vinyl-1,1′-(4′-phenyl)biphenylene, 1-vinyl-4-(phenyloxy)benzene, 1-vinyl-3-(phenyloxy)benzene, 1-vinyl-2-(phenyloxy)benzene, 1-vinyl-4-(phenyl carbonyl)benzene, 1-vinyl-3-(phenylcarboxy)benzene, 1-vinyl-2-(phenoxycarbonyl) benzene, allyl phenyl ether, 2-biphenylylallyl ether, allyl 4-phenoxyphenyl ether, allyl 2,4,6-tribromophenyl ether, allyl phenyl carbonate, 1-allyloxy-2-trifluoromethylbenzene, allylbenzene, 1-phenyl-2-prop-2-enylbenzene, 4-phenyl-1-butene, 4-phenyl-1-butene-4-ol, 1-(4-methylphenyl)-3-buten-1-ol, 1-(4-chlorophenyl)-3-buten-1-ol, 4-allyltoluene, 1-allyl-4-fluorobenzene, 1-allyl-2-methylbenzene, 1-allyl-3-methylbenzene, 1-allyl-3-methylbenzene, 2-allylanisole, 4-allylanisole, 1-allyl-4-(trifluromethyl)benzene, allylpentafluorobenzene, 1-allyl-2-methoxybenzene, 4-allyl-1,2-dimethoxybenzene, 2-allylphenol, 2-allyl-6-methylphenol, 4-allyl-2-methoxyphenol, 2-allyloxyanisole, 4-allyl-2-methoxyphenyl acetate, 2-allyl-6-methoxyphenol, 1-allyl-2-bromobezene, alpha-vinylbenzyl alcohol, 1-phenyl-3-butene-1-one, allylbenzyl ether, (3-allyloxy)propyl)benzene, allyl phenylethyl ether, 1-benzyloxy-4-pentene, (1-allyloxy)ethyl)-benzene, 1-phenylallyl ethyl ether, (2-methyl-2-(2-propenyloxy)propyl)benzene, ((5-hexenyloxy)methyl)benzene, 1-allyloxy-4-propoxybenzene, 1-phenoxy-4-(3-prop-2-enoxypropoxy)benzene, 6-(4′-Hydroxyphenoxy)-1-Hexene, 4-but-3-enoxyphenol, 1-allyloxy-4-butoxybenzene, 1-allyloxy-4-ethoxybenzene, 1-allyl-4-benzyloxybenzene, 1-allyl-4-(phenoxy)benzene, 1-allyl-3-(phenoxy)benzene, 1-allyl-2-(phenoxy)benzene, 1-allyl-4-(phenyl carbonyl)benzene, 1-allyl-3-(phenyl carboxy)benzene, 1-allyl-2-(phenoxycarbonyl)benzene, 1,2-allyl phenyl benzene, 1,3-allyl phenyl benzene, 1,4-allyl phenyl benzene, 4-vinyl-1,1′-(4′-phenyl)biphenylene, 1-allyl-4-(phenyloxy)benzene, 1-allyl-3-(phenyloxy)benzene, 1-allyl-2-(phenyloxy)benzene, 1-allyl-4-(phenyl carbonyl)benzene, 1-allyl-3-(phenyl carboxy)benzene, and 1-allyl-2-(phenoxycarbonyl)benzene, 1-vinyl naphthylene, 2-vinyl naphthylene, 1-allyl naphthalene, 2-allyl naphthalene, allyl-2-naphthyl ether, 2-(2-methylprop-2-enyl)naphthalene, 2-prop-2-enylnaphthalene, 4-(2-naphthyl)-1-butene, 1-(3-butenyl)naphthalene, 1-allyl naphthalene, 2-allyl naphthalene, 1-allyl-4-napthyl naphthalene, 2-(allyloxy)-1-bromonaphthalene, 2-bromo-6-allyloxynaphthalene, 1,2-vinyl(1-naphthyl)benzene, 1,2-vinyl(2-naphthyl)benzene, 1,3-vinyl(1-naphthyl)benzene, 1,3-vinyl(2-naphthyl)benzene, 1,4-vinyl(1-naphthyl)benzene, 1,4-vinyl(2-naphthyl)benzene, 1-naphthyl-4-vinyl naphthalene, 1-allyl naphthalene, 2-allyl naphthalene, 1,2-allyl(1-naphthyl) benzene, 1,2-allyl(2-naphthyl)benzene, 1,3-allyl(1-naphthyl)benzene, 1,3-allyl(2-naphthyl)benzene, 1,4-allyl(1-naphthyl)benzene, 1,4-allyl(2-naphthyl)benzene, 1-allyl-4-napthyl naphthalene, 1-vinyl anthracene, 2-vinyl anthracene, 9-vinyl anthracene, 1-allyl anthracene, 2-allyl anthracene, 9-allyl anthracene, 9-pent-4-enylanthracene, 9-allyl-1,2,3,4-tetrachloroanthracene, 1-vinyl phenanthrene, 2-vinyl phenanthrene, 3-vinyl phenanthrene, 4-vinyl phenanthrene, 9-vinyl phenanthrene, 1-allyl phenanthrene, 2-allyl phenanthrene, 3-allyl phenanthrene, 4-allyl phenanthrene, 9-allyl phenanthrene, and combinations thereof.

Example non-silicone aryl vinylic monomers are non-silicone aryl acrylic monomers which are N-phenyl (meth)acrylamide, N-benzyl (meth)acrylamide, N-(2-phenylethyl) (meth)acrylamide, 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; or combinations thereof. Non-silicone aryl acrylic monomers can enhance the refractive index and also provide hydrogen bond-donors and acceptors which can in turn provide strong interactions between the insert and the bulk silicone hydrogel material.

Any non-silicone aryl vinylic crosslinkers can be used. Examples of non-silicone aryl vinylic crosslinkers include non-silicone aryl vinylic crosslinkers (e.g., divinylbenzene, 2-methyl-1,4-divinylbenzene, bis(4-vinylphenyl)methane, 1,2-bis(4-vinylphenyl)ethane, etc.), and combinations thereof.

An insert-forming composition can further include at least one vinylic crosslinker free of aryl group (e.g., acrylic crosslinking agents (crosslinkers) as described below), at least one UV-absorbing vinylic monomer (any one of those described later in this application), at least one UV/HEVL-absorbing vinylic monomer (any one of those described later in this application), at least one photochromic vinylic monomer (any one of those described later in this application), at least one tinting agent (pigment particles or polymerizable dyes), or combinations thereof.

Examples of acrylic crosslinkers free of aryl group include ethylene glycol di-(meth)methacrylate; 1,3-propanediol di-(meth)acrylate; 2,3-propanediol diacrylate; 2,3-propanediol di-(meth)acrylate; 1,4-butanediol di-(meth)acrylate; 1,5-pentanediol di-(meth)acrylate; 1,6-hexanediol di-(meth)acrylate; diethylene glycol di-(meth)acrylate; triethylene glycol di-(meth)acrylate; tetraethylene glycol di-(meth)acrylate; glycerol 1,3-diglycerolate di-(meth)acrylate, ethylenebis[oxy(2-hydroxypropane-1,3-diyl)] di-(meth)acrylate, bis[2-(meth)acryloxyethyl]phosphate, trimethylolpropane di-(meth)acrylate, 3,4-bis[(meth)acryloyl]-tetrahydrofuan, diacrylamide, dimethacrylamide, N,N-di(meth)acryloyl-N-methylamine, N,N-di(meth)acryloyl-N-ethylamine, N,N′-methylene bis(acrylamide); N,N′-methylene bis(methacrylamide); N,N′-ethylene bis(acrylamide); N,N′-ethylene bis(methacrylamide); N,N′-hexamethylene bisacrylamide; N,N′-hexamethylene bismethacrylamide; N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamido-propane-2-yl dihydrogen phosphate, piperazine diacrylamide, pentaerythritol triacrylate, pentaerythritol trimethacrylate, trimethyloylpropane triacrylate, trimethyloylpropane trimethacrylate, tris(2-hydroxyethyl)isocyanurate triacrylate, tris(2-hydroxyethyl)isocyanurate trimethacrylate, 1,3,5-triacryloxylhexahydro-1,3,5-triazine, 1,3,5-trimethacryloxylhexahydro-1,3,5-triazine; pentaerythritol tetraacrylate, pentaerythritol tetramethacrylate, di(trimethyloyl-propane) tetraacrylate, di(trimethyloylpropane) tetramethacrylate, or combinations thereof. For example, an insert-forming composition includes diacrylamide, dimethacrylamide, N,N-di(meth)acryloyl-N-methylamine, N,N-di(meth)acryloyl-N-ethylamine, N,N′-methylene bis(acrylamide); N,N′-methylene bis(methacrylamide); N,N′-ethylene bis(acrylamide); N,N′-ethylene bis(methacrylamide); N,N′-hexamethylene bisacrylamide; N,N′-hexamethylene bismethacrylamide; N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, or combinations thereof.

Any thermal polymerization initiators can be used. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of thermal polymerization initiators include benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. For example, the thermal initiator can be 2,2′-azobis(isobutyronitrile) (AIBN or VAZO 64).

An insert-forming composition can be a solventless clear liquid prepared by mixing all polymerizable components (or materials) and other necessary component (or materials) or a solution prepared by dissolving all of the desirable components (or materials) in any suitable solvent, such as, a mixture of water and one or more organic solvents miscible with water, an organic solvent, or a mixture of one or more organic solvents, as known to a person skilled in the art. The term “solvent” or “no-reactive diluent” refers to a chemical that cannot participate in free-radical polymerization reaction (any of those solvents as described later in this application).

Examples of suitable solvents include acetone, methanol, cyclohexane, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. Example organic solvents include methanol, ethanol, 1-propanol, isopropanol, sec-butanol, tert-butyl alcohol, tert-amyl alcohol, acetone, methyl ethyl ketone, methyl isopropyl ketone, methyl propyl ketone, ethyl acetate, heptane, methylhexane (various isomers), methylcyclohexane, dimethylcyclopentane (various isomers), 2,2,4-trimethylpentane, and mixtures thereof.

### Refractive Bulk Material of Contact Lenses

Starting location of peripheral refractive add can vary from 0.5 mm to 3.0 mm away from the radial center. Peripheral refractive add power can vary from 0.5 D to 10 D. Peripheral add could be one continuous zone or could be multi-zones. If multi-zones, starting and ending point of subsequent power zones will vary (from radial center) to ensure distant dominance and optimize optics for pupil size at different light conditions. Add power zones and amount of power induced are adjustable and optimized to ensure good vision as well as achieving desired myopically defocused blue in the periphery.

In some embodiments, the refractive bulk material in the central optical zone (e.g., central optical zone 185) has a dioptric power of about −8 D to about 8 D, such as about −3 D to about 3 D, such as about −1 D to about 1 D, such as about 0 D. In some embodiments, the refractive bulk material in the peripheral optical zone (e.g., peripheral optical zone 190) has a dioptric power of about 0 D to about 8 D, such as about 1 D to about 5 D, such as about 2 D to about 4 D, such as about 3 D. The overall contact lens can have a dioptric power in the central optical zone (e.g., central optical zone 185) of about −10 D to about 6 D, such as about −3 D to about 3 D, such as about −1 D to about 1 D, such as about 0 D. Dioptric power of the peripheral optical zone can increase gradually across the peripheral optical zone or can be discrete. The overall contact lens can have a dioptric power in the peripheral optical zone (e.g., peripheral optical zone 190) of about 0 D to about 8 D, such as about 1 D to about 5 D, such as about 2 D to about 4 D, such as about 3 D.

In some embodiments, an eye care professional (ECP) can assess a patient as needing a particular diopter lens of the present disclosure, but nonetheless the ECP can intentionally prescribe a lower diopter lens than that of the assessment. In this way, blue wavelengths can be even lower contrast (further defocused) whereas red and/or green can be even higher contrast (further focused). For example, an ECP can determine that a patient's prescription under conventional circumstances is −4 D, but nonetheless prescribes −2 D lens of the present disclosure. In some embodiments, a difference in the assessed diopter and the prescribed diopter is about 0.5 D to about 4 D, such as about 1 D to about 3 D, such as about 1.5 D to about 2.5 D, such as about 2 D.

In accordance with some embodiments, a lens-forming composition is used to form the bulk material of a contact lens of the present disclosure. A silicone hydrogel (SiHy) lens-forming composition can include (i) at least one free-radical photoinitiator, (ii), at least one polysiloxane vinylic crosslinker optionally having a number average molecular weight of at least 4000 (such as at least 5000, such as at least 6000, such as at least 8000) Daltons in an amount of about 35% to about 80% (such as about 40% to about 75%, such as about 45% to about 70%) by weight relative to the total amount of all polymerizable components in the lens-forming composition, and (iii) optionally at least one component selected from at least one silicone-containing vinylic monomer, at least one non-silicone vinylic crosslinker, at least one non-silicone hydrophobic vinylic monomer, at least one UV-absorbing vinylic monomer, at least one HEVL-absorbing vinylic monomer, a visibility tinting agent, or combinations thereof.

Any free-radical photoinitiators known to a person skilled in the art can be used. Suitable photoinitiators are benzoin methyl ether, diethoxyacetophenone, a benzoylphosphine oxide, 1-hydroxycyclohexyl phenyl ketone and Darocur and Irgacur types, such as Darocur 1173® and Darocur 2959®, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenyl-phosphine oxide; and bis-(2,6-dichlorobenzoyl)-4-N-butylphenylphosphine oxide.

Any polysiloxane vinylic crosslinkers can be used so long they have a number average molecular weight of at least 4000 (such as at least 5000, such as at least 6000, such as at least 8000) Daltons. Examples of polysiloxane vinylic crosslinkers include α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with diamino-terminated polysiloxanes; the reaction products of glycidyl methacrylate with dihydroxyl-terminated polysiloxanes; the reaction products of an azlactone-containing vinylic monomer (any one of those described above) with di-hydroxyl-terminated polydimethylsiloxanes; the reaction products of isocyantoethyl (meth)acrylate with di-hydroxyl-terminated polydimethylsiloxanes; the reaction products of isocyantoethyl (meth)acrylate with diamino-terminated polydimethylsiloxanes; polysiloxane-containing macromer selected from Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047. It is understood that any silicone-containing vinylic crosslinker used in a lens-forming composition can be free of any aryl group, so as to ensure that the silicone hydrogel material of the insert has a higher refractive index than the bulk silicone hydrogel material.

One class of polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyantoethyl (meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such polysiloxane vinylic crosslinkers include α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxy-propyl]-terminated polydimethylsiloxane, α,ω-bis[3-(meth)acryloxybutyloxy-2-hydroxypropyloxy-propyl]-terminated polydimethylsiloxane, α,ω-bis[3-(meth)acrylamidoethoxy-2-hydroxypropyloxy-propyl]-terminated polydimethylsiloxane, α,ω-bis[3-(meth)acrylamidopropyloxy-2-hydroxy-propyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethyl-amino-2-hydroxypropyloxypropyl]-terminated polydimethylsiloxane, α,ω-bis[3-(meth)acryloxy-propylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and combinations thereof.

Another class of polysiloxane vinylic crosslinkers are chain-extended polysiloxane vinylic crosslinkers each of which includes at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10301451 and in U.S. Pat. App. Pub. No. 2018-0100038 A1.

A further class of polysiloxane vinylic crosslinkers are hydrophilized polysiloxane vinylic crosslinkers that each include at least about 1.50 (such as at least about 2.0, such as at least about 2.5, such as at least about 3.0) milliequivalent/gram (“meq/g”) of hydrophilic moieties, which can be hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of [symbol] C₂H₄O [symbol] ₙT₁ in which n is an integer of 2 to 20 and T₁ is H, methyl or acetyl or a phosphorylcholine group, or combinations thereof.

Examples of such hydrophilized polysiloxane vinylic crosslinkers are those compounds of formula (1)

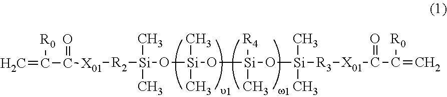

in which:
ν1 is an integer of from 30 to 500 and ω1 is an integer of from 1 to 75, provided that ω1/ν1 is about 0.035 to about 0.15 (such as about 0.040 to about 0.12, such as about 0.045 to about 0.10);
X₀₁ is O or NRₙ in which Rₙ is hydrogen or C₁-C₁₀-alkyl;
Rₒ is hydrogen or methyl;
R₂ and R₃ independently of each other are a substituted or unsubstituted C₁-C₁₀ alkylene divalent radical or a divalent radical of —R₅—O—R₆— in which R₅ and R₆ independently of each other are a substituted or unsubstituted C₁-C₁₀ alkylene divalent radical;
R₄ is a monovalent radical of any one of formula (2) to (7)

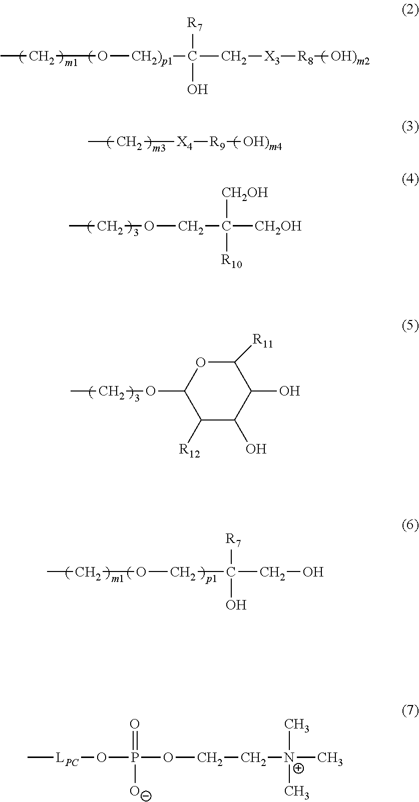

p1 is zero or 1; m1 is an integer of 2 to 4; m2 is an integer of 1 to 5; m3 is an integer of 3 to 6; m4 is an integer of 2 to 5;
R₇ is hydrogen or methyl;
R₈ is a C₂-C₆ hydrocarbon radical having (m2+1) valencies;
R₉ is a C₂-C₆ hydrocarbon radical having (m4+1) valencies;
R₁₀ is ethyl or hydroxymethyl;
R₁₁ is methyl or hydromethyl;
R₁₂ is hydroxyl or methoxy;
X₃ is a sulfur linkage of —S— or a tertiary amino linkage of —NR₁₃— in which R₁₃ is C₁-C₁ alkyl, hydroxyethyl, hydroxypropyl, or 2,3-dihydroxypropyl;
X₄ is an amide linkage of

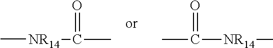

in which R₁₄ is hydrogen or C₁-C₁₀ alkyl;
L_{PC} is a divalent radical of

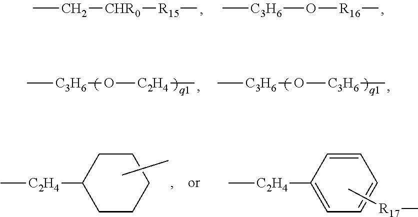

in which q1 is an integer of 1 to 20, R₁₅ is a linear or branched C₁-C₁₀ alkylene divalent radical, R₁₆ is a linear or branched C₃-C₁₀ alkylene divalent radical, and R₁₇ is a direct bond or a linear or branched C₁-C₄ alkylene divalent radical.

Hydrophilized polysiloxane vinylic crosslinker of formula (1) can be prepared according to the procedures disclosed in U.S. patent Ser. No. 10/081,697 and U.S. Pat. Appl. Pub. No. 2022/0251302 A1.

Any hydrophilic vinylic monomers can be used. Examples of hydrophilic vinylic monomers are alkyl (meth)acrylamides, hydroxyl-containing acrylic monomers, amino-containing acrylic monomers, carboxyl-containing acrylic monomers, N-vinyl amide monomers, methylene-containing pyrrolidone monomers (i.e., pyrrolidone derivatives each having a methylene group connected to the pyrrolidone ring at 3- or 5-position), acrylic monomers having a C₁-C₄ alkoxyethoxy group, vinyl ether monomers, allyl ether monomers, phosphorylcholine-containing vinylic monomers, N-2-hydroxyethyl vinyl carbamate, N-carboxyvinyl-β-alanine (VINAL), N-carboxyvinyl-α-alanine, and combinations thereof.

Examples of alkyl (meth)acrylamides include (meth)acrylamide, N,N-dimethyl (meth)acrylamide, N-methyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

Examples of hydroxyl-containing acrylic monomers include N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof.

Examples of carboxyl-containing acrylic monomers include 2-(meth)acrylamidoglycolic acid, (meth)acrylic acid, ethylacrylic acid, 3-(meth)acrylamido-propionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl 3,3-dimethyl butanoic acid, 3-(meth)acrylamidohaxanoic acid, 4-(meth)acrylamido-3,3-dimethylhexanoic acid, and combinations thereof.

Examples of amino-containing acrylic monomers include N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof.

Examples of N-vinyl amide monomers include N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof.

Examples of methylene-containing pyrrolidone monomers include 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and mixtures thereof.

Examples of acrylic monomers having a C₁-C₄ alkoxyethoxy group include ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof.

Examples of vinyl ether monomers include ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of allyl ether monomers include ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of phosphorylcholine-containing vinylic monomers include (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethyl-phosphate, 2-((meth)acryloyloxy)ethyl-2′-(tripropylammonio)ethylphosphate, 2-((meth)acryloxy)-ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethyl-phosphate, 2-(vinylcarbonyl-amino)ethyl-2′-(trimethylammonio)ethylphosphate, 2-(allyloxycarbonylamino)-ethyl-2′-(trimethylammonio)ethyl phosphate, 2-(butenoyloxy)ethyl-2′-(trimethylammonio)-ethylphosphate, and combinations thereof.

In at least one embodiment, a lens-forming composition includes at least one hydrophilic (meth)acrylamido monomer, such as those selected from N,N-dimethyl acrylamide, N-methyl acrylamide, N-ethyl acrylamide, N,N-dimethyl methacrylamide, N-methyl methacrylamide, N-ethyl methacrylamide, or combinations thereof.

Any silicone-containing vinylic monomer known to a person skilled in the art can be used. Examples of silicone-containing vinylic monomers include vinylic monomers each having a bis(trialkylsilyloxy)alkylsilyl group (such as a bis(trimethylsilyloxy)-alkylsilyl group) or a tris(trialkylsilyloxy)silyl group (such as a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof. It is understood that any silicone-containing vinylic monomer used in a lens-forming composition can be free of any aryl group, so as to ensure that the silicone hydrogel material of the insert has a higher refractive index than the bulk silicone hydrogel material.

Examples of siloxane-containing vinylic monomers each having a bis(trialkylsilyloxy)alkylsilyl group or a tris(trialkylsilyloxy)silyl group include tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propyl-bis(trimethylsiloxy)-methylsilane, 3-(meth)acryloxy-2-hydroxypropyloxy)propyltris(trimethylsiloxy) silane, N-[tris(trimethylsiloxy)silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)propyloxy)propyl) (meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethyl-ethylsiloxy)silylpropyl](meth)acrylamide, N,N-bis[2-hydroxy-3-(3-(bis(trimethylsilyloxy)-methylsilyl)propyloxy)propyl]-2-methyl (meth)acrylamide, N,N-bis[2-hydroxy-3-(3-(bis(trimethyl-silyloxy)methylsilyl)propyloxy)-propyl](meth)acrylamide, N,N-bis[2-hydroxy-3-(3-(tris(trimethyl-silyloxy)silyl)propyloxy)propyl]-2-methyl (meth)acrylamide, N,N-bis[2-hydroxy-3-(3-(tris(trimethyl-silyloxy)silyl)propyloxy)propyl](meth)acrylamide, N-[2-hydroxy-3-(3-(t-butyldimethylsilyl)-propyloxy)propyl]-2-methyl (meth)acrylamide, N-[2-hydroxy-3-(3-(t-butyldimethylsilyl)propyloxy)-propyl](meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, those disclosed in U.S. Pat. Nos. 9,097,840, 9,103,965 and 9,475,827 (herein incorporated by references in their entireties), and mixtures thereof. The above silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of polysiloxane vinylic monomers include mono-(meth)acryloyl-terminated, monoalkyl-terminated polysiloxanes of formula (I) include α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl]terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyl-tetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above polysiloxanes vinylic monomers can be obtained from commercial suppliers (e.g., Shin-Etsu, Gelest, etc.) or prepared according to procedures described in patents, e.g., U.S. Pat. Appl. Pub. Nos. 6166236, 6867245, 8415405, 8475529, 8614261, 9217813, and 9315669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

Any non-silicone vinylic crosslinkers (free of aryl group) can be used. Examples of non-silicone vinylic cross-linking agents include: acrylic crosslinkers (free of aryl group) as described above, allyl methacrylate, allyl acrylate, N-allyl-methacrylamide, N-allyl-acrylamide, tetraethyleneglycol divinyl ether, triethyleneglycol divinyl ether, diethyleneglycol divinyl ether, ethyleneglycol divinyl ether, triallyl isocyanurate, 2,4,6-triallyloxy-1,3,5-triazine, 1,2,4-trivinylcyclohexane, or combinations thereof.

Any non-silicone hydrophobic vinylic monomers can be used. Examples of hydrophobic non-silicone vinylic monomers can be non-silicone hydrophobic acrylic monomers (methyl (meth)acrylate, ethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), fluorine-containing acrylic monomers (e.g., perfluorohexylethyl-thio-carbonyl-aminoethyl-methacrylate, perfluoro-substituted-C₂-C₁₂ alkyl (meth)acrylates described below, etc.), vinyl alkanoates (e.g., vinyl acetate, vinyl propionate, vinyl butyrate, vinyl valerate, etc.), vinyloxyalkanes (e.g., vinyl ethyl ether, propyl vinyl ether, n-butyl vinyl ether, isobutyl vinyl ether, cyclohexyl vinyl ether, t-butyl vinyl ether, etc.), styrene, vinyl toluene, vinyl chloride, vinylidene chloride, 1-butene, and combinations thereof.

Any suitable perfluoro-substituted-C₂-C₁₂ alkyl (meth)acrylates can be used. Examples of perfluoro-substituted-C₂-C₁₂ alkyl (meth)acrylates include 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, and combinations thereof.

In accordance with some embodiments, the SiHy lens-forming composition can also include other polymerizable materials, such as, a UV-absorbing vinylic monomer, a UV/high-energy-violet-light (“HEVL”) absorbing vinylic monomer, polymerizable photochromic compound, a polymerizable tinting agent (polymerizable dye), or combinations thereof, as known to a person skilled in the art.

Any suitable UV-absorbing vinylic monomers and UV/high-energy-violet-light (“HEVL”) absorbing vinylic monomers can be used. Examples of UV-absorbing and UV/HEVL-absorbing vinylic monomers include: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl- (UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9CI) (CAS #83063-87-0). In accordance with some embodiments, the polymerizable composition includes about 0.1% to about 3.0%, such as about 0.2% to about 2.5%, such as about 0.3% to about 2.0%, by weight of one or more UV-absorbing vinylic monomers, related to the amount of all polymerizable components in the polymerizable composition.

Numerous SiHy lens formulations have been described in numerous patents and patent applications published by the filing date of this application and have been used in producing commercial SiHy contact lenses. Examples of commercial SiHy contact lenses include asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a lens-forming composition of the present disclosure.

A SiHy lens-forming composition is prepared by dissolving all of the desirable components (or materials) in one or more non-reactive diluents (solvents) as described above or a reactive solvent (e.g., methyl methacrylate, styrene, etc.).

In accordance with some embodiments, a lens-forming composition can form a SiHy material that, in fully hydrated state, has an equilibrium water content of about 20% to about 60% (such as about 20% to about 55%, such as about 20% to about 50%, such as about 20% to about 45%) by weight, an oxygen permeability of at least 40 barrers (such as at least 50 barrers, such as at least 60 barrers, such as at least 70 barrers), and a modulus (i.e., Young's modulus) of about 1.5 MPa or less (such as about 0.2 MPa to about 1.2 MPa, such as about 0.3 MPa to about 1.1 MPa, such as about 0.4 MPa to about 1.0 MPa).

The insert-forming composition and the lens-forming composition can be introduced into the insert-molding cavity and the lens-molding cavity respectively according to any techniques known to a person skilled in the art.

When the first molding assembly is closed, any excess insert-forming composition is pressed into an overflow groove provided on the male insert mold half or the female insert mold half on its molding surface. The overflow groove surrounds the molding surface defining one of the front or back surface of an insert to be molded.

When the second molding assembly is closed, any excess lens-forming composition is pressed into an overflow groove provided on either one of the female lens mold half and/or the male lens mold half. The overflow groove surrounds the molding surface defining one of the anterior and posterior surfaces of a contact lens to be molded.

The thermal polymerization of the insert-forming composition in the first molding assembly can be carried out conveniently in an oven at a temperature of from 25 to 120° C., such as 40 to 100° C., as well known to a person skilled in the art. The reaction time may vary within wide limits, but is conveniently, for example, from 1 to 24 hours or from 2 to 12 hours. It is advantageous to previously degas the silicone-hydrogel-lens-forming composition and to carry out said copolymerization reaction under an inert atmosphere, e.g., under N₂ or Ar atmosphere.

The process of separating the first molding assembly can be carried out according to any techniques known to a person skilled in the art. It is understood that the molded insert is adhered onto the female mold. As an illustrative example, the first male mold half can be blasted with liquid nitrogen for several seconds and then pinched.

The actinic polymerization of the lens-forming composition in the second molding assembly can be carried out by irradiating the closed molding assembly with the lens-forming composition therein with an UV or visible light, according to any techniques known to a person skilled in the art.

The process of separating the second molding assembly can be carried out according to any techniques known to a person skilled in the art. It is understood that the molded embedded hydrogel contact lens can be adhered onto either one of the two mold halves of the second molding assembly. As an illustrative example, a compression force can be applied by using a mold-opening device to non-optical surface (opposite to the molding surface) of one of the mold halves (not adhering the molded insert) of the second molding assembly at a location about the center area of non-optical molding surface at an angle of less than about 30 degrees, less than about 10 degrees, or less than about 5 degrees (i.e., in a direction substantially normal to center area of non-optical molding surface) relative to the axis of the mold to deform the mold half, thereby breaking bonds between the molding surface of the mold half and the molded lens. Various ways of applying a force to non-optical surface of the mold half at a location about the center area of non-optical molding surface along the axis of the mold to deform the mold half which breaks the bonds between the optical molding surface of the mold half and the molded lens. It is understood that the mold-opening device can have any configurations known to a person skilled in the art for performing the function of separating two mold halves from each other.

The embedded diffractive SiHy contact lens precursor can be delensed (i.e., removed) from the lens-adhered mold half according to any techniques known to a person skilled in the art.

After the embedded diffractive SiHy contact lens precursor is delensed, it typically is extracted with an extraction medium as well known to a person skilled in the art. The extraction liquid medium is any solvent capable of dissolving the diluent(s), unpolymerized polymerizable materials, and oligomers in the embedded diffractive SiHy contact lens precursor. Water, any organic solvents known to a person skilled in the art, or a mixture thereof can be used in the present disclosure. For example, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

The extracted embedded diffractive SiHy contact lens can then be hydrated according to any method known to a person skilled in the art.

The hydrated embedded diffractive SiHy contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used. For example, a lens package is a blister package which includes a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

### Methods of Making Contact Lenses

In some embodiments, a method for producing embedded silicone hydrogel contact lenses includes the processes of: (1) obtaining a female lens mold half, a male insert mold half and a male lens mold half, wherein the female lens mold half has a first molding surface defining the anterior surface of a contact lens to be molded, wherein the male insert mold half has a second molding surface defining the back surface of an insert to be molded and a diffractive optics structure thereon, wherein the male lens mold half has a third molding surface defining the posterior surface of the contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half, (2) dispensing an amount of an insert-forming composition on the central portion of the first molding surface of the female lens mold half, wherein the insert-forming composition includes (i) at least one thermal free-radical initiator and (ii) (a) about 24.5% to about 75.0% by weight of at least one silicone-containing aryl vinylic monomer and/or (b) about 24.5% to about 75.0% by weight of at least one silicone-containing aryl vinylic crosslinker relative to the total weight of all polymerizable components in the insert-forming composition, wherein the sum of the amounts of components (a) and (b) is at least 55% (such as at least 60%, such as at least 65%, such as at least 70%, such as at least 75%) by weight; (3) placing the male insert mold half on top of the insert-forming composition in the female lens mold half and closing the male insert mold half and the female lens mold half to form a first molding assembly including the insert-forming composition within the insert-molding cavity; (4) thermally curing the insert-forming composition in the insert-molding cavity of the first molding assembly to form a diffractive insert includes a crosslinked silicone-containing vinyl copolymer (for example, having an oxygen permeability of at least 30 barrers (such as at least 40 barrers, such as at least 55 barrers, such as at least 70 barrers)) and having a first refractive index in fully hydrated state, wherein the diffractive insert includes a diffractive optics structure created on the back surface of the diffractive insert; (5) separating the first molding assembly obtained in process (4) into the male insert mold half and the female lens mold half with the diffractive insert that is adhered onto the central portion of the first molding surface; (6) dispensing a lens-forming composition in the female lens mold half with the diffractive insert adhered thereon in an amount sufficient for filling the lens-molding cavity, wherein the lens-forming composition includes (i) at least one free-radical photoinitiator and (ii) at least one polysiloxane vinylic crosslinker (for example, having a number average molecular weight of at least 4000 (such as at least 5000, such as at least 6000, such as at least 8000) Daltons) in an amount of about 35% to about 80% (such as about 40% to about 75%, such as about 45% to about 70%) by weight relative to the total amount of all polymerizable components in the lens-forming composition and is capable of forming a silicone hydrogel material (for example, having a glass transition temperature of about 20° C. or lower (such as about 15° C. or lower, such as about 10° C. or lower, such as about 5° C. or lower)) and having a second refractive index in fully hydrated state, wherein the first refractive index is optionally at least 0.03 higher than the second refractive index; (7) placing the male lens mold half on top of the lens-forming composition in the female lens mold half and closing the male lens mold half and the female lens mold half to form a second molding assembly including the lens-forming composition and the diffractive insert immersed therein in the lens-molding cavity; (8) actinically curing the lens-forming composition with the molded insert immersed therein in the lens-molding cavity of the second molding assembly to form an embedded diffractive contact lens precursor that includes the silicone hydrogel material as bulk hydrogel material and the diffractive insert embedded in the silicone hydrogel material; (9) separating the second molding assembly obtained in process (8) into the male lens mold half and the female lens mold half, with the embedded diffractive contact lens precursor adhered on a lens-adhered mold half which is one of the female or second male lens mold halves; (10) removing the embedded diffractive contact lens precursor from the lens-adhered lens mold half (such as before the embedded diffractive contact lens precursor is contacted with water or other liquid); and (11) subjecting the embedded diffractive contact lens precursor to post-molding processes including one or more processes selected from extraction, hydration, surface treatment, packaging, sterilization, and combinations thereof, to obtain an embedded diffractive contact lens that is substantially or completely free of delamination and substantially or completely free of distortion and/or defects at the interface between the diffractive insert and the silicone hydrogel material when inspecting a microscopic image of a lens cross section of the embedded diffractive SiHy contact lens.

In another embodiment, a method for producing embedded silicone hydrogel contact lenses includes the processes of: (1) obtaining a female insert mold half, a male lens mold half and a female lens mold half, wherein the female insert mold half has a fourth molding surface defining the front surface of an insert to be molded and a diffractive optics structure thereon, wherein the male lens mold half has a third molding surface defining the posterior surface of a contact lens to be molded, wherein the female lens mold half has a first molding surface defining the anterior surface of the contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half; (2) dispensing an amount of an insert-forming composition on the fourth molding surface of the female insert mold half, wherein the insert-forming composition includes (i) at least one thermal free-radical initiator and (ii) (a) about 24.5% to about 75.0% by weight of at least one silicone-containing aryl vinylic monomer and/or (b) about 24.5% to about 75.0% by weight of at least one silicone-containing aryl vinylic crosslinker relative to the total weight of all polymerizable components in the insert-forming composition, wherein the sum of the amounts of components (a) and (b) is at least 55% (such as at least 60%, such as at least 65%, such as at least 70%, such as at least 75%) by weight; (3) placing the male lens mold half on top of the insert-forming composition in the female insert mold half and closing the female insert mold half and the male lens mold half to form a first molding assembly including the insert-forming composition within the insert-molding cavity; (4) thermally curing the insert-forming composition in the insert-molding cavity of the first molding assembly to form a diffractive insert includes a crosslinked silicone-containing vinyl copolymer having an oxygen permeability of at least 30 barrers (such as at least 40 barrers, such as at least 55 barrers, such as at least 70 barrers) and a first refractive index in fully hydrated state, wherein the diffractive insert includes a diffractive optics structure created on the front surface of the diffractive insert; (5) separating the first molding assembly obtained in process (4) into the female insert mold half and the male lens mold half with the molded insert that is adhered onto the central portion of the third molding surface; (6) dispensing a lens-forming composition in the female lens mold half in an amount sufficient for filling the lens-molding cavity, wherein the lens-forming composition includes (i) at least one free-radical photoinitiator and (ii) at least one polysiloxane vinylic crosslinker having a number average molecular weight of at least 4000 (such as at least 5000, such as at least 6000, such as at least 8000) Daltons in an amount of about 35% to about 80% (such as about 40% to about 75%, such as about 45% to about 70%) by weight relative to the total amount of all polymerizable components in the lens-forming composition and is capable of forming a silicone hydrogel material having a glass transition temperature of about 20° C. or lower (such as about 15° C. or lower, such as about 10° C. or lower, such as about 5° C. or lower) and a second refractive index in fully hydrated state, wherein the first refractive index is optionally at least 0.03 higher than the second refractive index; (7) placing the male lens mold half with the molded insert adhered thereon on top of the lens-forming composition in the female lens mold half and closing the female lens mold half and the male lens mold half to form a second molding assembly including the lens-forming composition and the diffractive insert immersed therein in the lens-molding cavity; (8) actinically curing the lens-forming composition with the diffractive insert immersed therein in the lens-molding cavity of the second molding assembly to form an embedded diffractive contact lens precursor that include the silicone hydrogel material as bulk hydrogel material and the diffractive insert embedded in the silicone hydrogel material; (9) separating the second molding assembly obtained in process (8) into the female lens mold half and the male lens mold half, with the embedded diffractive contact lens precursor adhered on a lens-adhered lens mold half which is one of the male and female lens mold halves; (10) removing the embedded diffractive contact lens precursor from the lens-adhered lens mold half (such as before the embedded diffractive contact lens precursor is contact with water or other liquid); and (11) subjecting the embedded diffractive contact lens precursor to post-molding processes including a hydration process and one or more other processes selected from extraction, surface treatment, packaging, sterilization, and combinations thereof, to obtain an embedded diffractive contact lens that is substantially or completely free of delamination and substantially or completely free of distortion and/or defects at the interface between the diffractive insert and the silicone hydrogel material when inspecting a microscopic image of a lens cross section of the embedded diffractive SiHy contact lens.

Mold halves for making contact lenses (or inserts) are well known to a person skilled in the art and, for example, are employed in cast molding. In general, a molding assembly includes at least two mold halves, one male half and one female mold half. The male mold half has a molding (or optical) surface which is in direct contact with a polymerizable composition for cast molding of a contact lens (or an insert) and defines the posterior (back) surface of a molded contact lens (or a molded insert); and the female mold half has a molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

In some embodiments, the male insert mold half or the female insert mold half for forming the first molding assembly include an overflow groove which surrounds the molding surface and receives any excess insert-forming material when the first molding assembly is closed. By having such an overflow groove, one can ensure that any flushes formed from the excess insert-forming material during molding of the insert can be stuck on the male or female insert mold half during the process of separating the first molding assembly, thereby removing the flushes.

Methods of manufacturing mold halves for cast-molding a contact lens or an insert are generally well known to those of ordinary skill in the art. The process of the present disclosure is not limited to any particular method of forming a mold half. In fact, any method of forming a mold half can be used in the present disclosure. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

### Additional Embodiments

In some embodiments, a method produces embedded diffractive silicone hydrogel contact lenses each of which includes a diffractive insert including a crosslinked silicone-rich material having a high refractive index and is embedded with a silicone hydrogel with a lower refractive index in a cost-effective manner. When a lens-forming composition includes a significant amount of at least one high molecular weight polysiloxane vinylic crosslinker as the main (predominant) hydrophobic polymerizable component for forming a silicone hydrogel material having a glass transition temperature of about 20° C. or lower, such a lens-forming composition can be used to cast-mold embedded diffractive silicone hydrogel contact lenses each of which includes a diffractive silicone-rich insert embedded within a bulk silicone hydrogel material and is not only be not susceptible to delamination but also is substantially or completely free of distortion and defects at the interface between the bulk SiHy material and the diffractive insert when inspecting a microscopic image of a lens cross section of the embedded diffractive SiHy contact lens. It is believed that by using a high molecular weight polysiloxane vinylic crosslinker as the main hydrophobic polymerizable component, one can minimize the penetration of polymerizable components in a lens-forming composition during cast molding process, thereby minimizing distortion at the interface between the diffractive silicone-rich insert and the silicone hydrogel material. It is also believed that by having a low glass transition temperature, the bulk silicone hydrogel material can be more compatible with the silicone-rich material of the diffractive insert, especially during drying process and sterilization (autoclave). One could minimize internal stress introduced during manufacturing processes at interfaces between the diffractive insert and the bulk silicone hydrogel material, thereby maintaining the fidelity of the diffractive optics structures of the embedded diffractive SiHy contact lenses. A method of the present disclosure can offer the following advantages. First, a method can be easily implemented in an automatic product line for producing embedded hydrogel contact lenses in mass. Second, because the diffractive structure is buried inside the contact lens, the changes in tear film thickness would not adversely affect the diffractive power of the contact lens and the contact lens would have smooth anterior and posterior surfaces for wearing comfort.

In at least one aspect, a method for producing embedded silicone hydrogel contact lenses includes the processes of: (1) obtaining a female lens mold half, a male insert mold half and a male lens mold half, wherein the female lens mold half has a first molding surface defining the anterior surface of a contact lens to be molded, wherein the male insert mold half has a second molding surface defining the back surface of an insert to be molded and a diffractive optics structure thereon, wherein the male lens mold half has a third molding surface defining the posterior surface of the contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half, (2) dispensing an amount of an insert-forming composition on the central portion of the first molding surface of the female lens mold half, wherein the insert-forming composition includes (i) at least one thermal free-radical initiator and (ii) about 24.5% to about 75.0% by weight of at least one silicone-containing aryl vinylic monomer and/or about 24.5% to about 75.0% by weight of at least one silicone-containing aryl vinylic crosslinker, relative to the total weight of all polymerizable components in the insert-forming composition, wherein the sum of the amounts of said at least one polysiloxane vinylic crosslinker and said at least one silicone-containing vinylic monomer is at least 55% by weight; (3) placing the male insert mold half on top of the insert-forming composition in the female lens mold half and closing the male insert mold half and the female lens mold half to form a first molding assembly including the insert-forming composition within the insert-molding cavity; (4) thermally curing the insert-forming composition in the insert-molding cavity of the first molding assembly to form a diffractive insert including a crosslinked silicone-containing vinyl copolymer having an oxygen permeability of at least 30 barrers and a first refractive index in fully hydrated, wherein the diffractive insert includes a diffractive optics structure created on the back surface of the diffractive insert; (5) separating the first molding assembly obtained in process (4) into the male insert mold half and the female lens mold half with the diffractive insert that is adhered onto the central portion of the first molding surface; (6) dispensing a lens-forming composition in the female lens mold half with the diffractive insert adhered thereon in an amount sufficient for filling the lens-molding cavity, wherein the lens-forming composition includes (i) at least one free-radical photoinitiator and (ii) at least one polysiloxane vinylic crosslinker having a number average molecular weight of at least 4000 Daltons in an amount of about 45% to about 80% by weight relative to the total amount of all polymerizable components in the lens-forming composition and is capable of forming a silicone hydrogel material having a glass transition temperature of about 20° C. or lower and a second refractive index in fully hydrated state, wherein the first refractive index is at least 0.03 higher than the second refractive index; (7) placing the male lens mold half on top of the lens-forming composition in the female lens mold half and closing the male lens mold half and the female lens mold half to form a second molding assembly including the lens-forming composition and the diffractive insert immersed therein in the lens-molding cavity; (8) actinically curing the lens-forming composition with the molded insert immersed therein in the lens-molding cavity of the second molding assembly to form an embedded diffractive contact lens precursor that includes the silicone hydrogel material as bulk hydrogel material and the diffractive insert embedded in the silicone hydrogel material; (9) separating the second molding assembly obtained in process (8) into the male lens mold half and the female lens mold half, with the embedded diffractive contact lens precursor adhered on a lens-adhered mold half which is one of the female and second male lens mold halves; (10) removing the embedded diffractive contact lens precursor from the lens-adhered lens mold half (such as before the embedded diffractive contact lens precursor is contacted with water or other liquid); and (11) subjecting the embedded diffractive contact lens precursor to post-molding processes including one or more processes selected from extraction, hydration, surface treatment, packaging, sterilization, and combinations thereof, to obtain an embedded diffractive contact lens that is free of delamination and free of distortion and/or defects at the interface between the diffractive insert and the silicone hydrogel material when inspecting a microscopic image of a lens cross section of the embedded diffractive SiHy contact lens.

In some embodiments, a method for producing embedded silicone hydrogel contact lenses includes the processes of: (1) obtaining a female insert mold half, a male lens mold half and a female lens mold half, wherein the female insert mold half has a fourth molding surface defining the front surface of an insert to be molded and a diffractive optics structure thereon, wherein the male lens mold half has a third molding surface defining the posterior surface of a contact lens to be molded, wherein the female lens mold half has a first molding surface defining the anterior surface of the contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half, (2) dispensing an amount of an insert-forming composition on the fourth molding surface of the female insert mold half, wherein the insert-forming composition includes (i) at least one thermal free-radical initiator and (ii) about 24.5% to about 75.0% by weight of at least one silicone-containing aryl vinylic monomer and/or about 24.5% to about 75.0% by weight of at least one silicone-containing aryl vinylic crosslinker, relative to the total weight of all polymerizable components in the insert-forming composition, wherein the sum of the amounts of said at least one polysiloxane vinylic crosslinker and said at least one silicone-containing vinylic monomer is at least 55% by weight; (3) placing the male lens mold half on top of the insert-forming composition in the female insert mold half and closing the female insert mold half and the male lens mold half to form a first molding assembly including the insert-forming composition within the insert-molding cavity; (4) thermally curing the insert-forming composition in the insert-molding cavity of the first molding assembly to form a diffractive insert including a crosslinked silicone-containing vinyl copolymer having an oxygen permeability of at least 30 barrers and a first refractive index in fully hydrated, wherein the diffractive insert includes a diffractive optics structure created on the front surface of the diffractive insert; (5) separating the first molding assembly obtained in process (4) into the female insert mold half and the male lens mold half with the molded insert that is adhered onto the central portion of the third molding surface; (6) dispensing a lens-forming composition in the female lens mold half in an amount sufficient for filling the lens-molding cavity, wherein the lens-forming composition includes (i) at least one free-radical photoinitiator and (ii) at least one polysiloxane vinylic crosslinker having a number average molecular weight of at least 4000 Daltons in an amount of about 45% to about 80% by weight relative to the total amount of all polymerizable components in the lens-forming composition and is capable of forming a silicone hydrogel material having a glass transition temperature of about 20° C. or lower and a second refractive index in fully hydrated state, wherein the first refractive index is at least 0.03 higher than the second refractive index; (7) placing the male lens mold half with the molded insert adhered thereon on top of the lens-forming composition in the female lens mold half and closing the female lens mold half and the male lens mold half to form a second molding assembly including the lens-forming composition and the diffractive insert immersed therein in the lens-molding cavity; (8) actinically curing the lens-forming composition with the diffractive insert immersed therein in the lens-molding cavity of the second molding assembly to form an embedded diffractive contact lens precursor that includes the silicone hydrogel material as bulk hydrogel material and the diffractive insert embedded in the silicone hydrogel material; (9) separating the second molding assembly obtained in process (8) into the female lens mold half and the male lens mold half, with the embedded diffractive contact lens precursor adhered on a lens-adhered lens mold half which is one of the male and female lens mold halves; (10) removing the embedded diffractive contact lens precursor from the lens-adhered lens mold half (for example, before the embedded diffractive contact lens precursor is contact with water or any liquid); and (11) subjecting the embedded diffractive contact lens precursor to post-molding processes including a hydration process and one or more other processes selected from extraction, surface treatment, packaging, sterilization, and combinations thereof, to obtain an embedded diffractive contact lens that is free of delamination and free of distortion and/or defects at the interface between the diffractive insert and the silicone hydrogel material when inspecting a microscopic image of a lens cross section of the embedded diffractive SiHy contact lens.

In some embodiments, an embedded diffractive silicone hydrogel contact lens, includes a lens body that includes: an anterior surface; an opposite posterior surface, a bulk silicone hydrogel material; and a diffractive insert embedded in the bulk silicone hydrogel material, wherein the insert includes a crosslinked silicone-containing vinyl copolymer different from the bulk silicone hydrogel material and has a convex front surface, an opposite concave back surface and a diameter up to about 10.0 mm, wherein the insert is located in a central portion of the embedded diffractive silicone hydrogel contact lens and concentric with a central axis of the lens body, wherein one of the convex front and concave back surfaces of the diffractive insert merges with the anterior or posterior surface of the lens body and is designated as exposing surface while the other one of the convex front and concave back surfaces of the diffractive insert is buried in and in contact with the bulk silicone hydrogel material and is designated as buried surface, wherein the buried surface of the diffractive insert includes a diffractive optics structure, wherein the crosslinked silicone-containing vinyl copolymer includes (a) about 24.5% to about 75.0% by weight of repeating units of at least one silicone-containing aryl vinylic monomer and/or (b) about 24.5% to about 75.0% by weight of repeating units of at least one silicone-containing aryl vinylic crosslinker and in fully hydrated state has an oxygen permeability of at least 30 barrers and a refractive index that is at least 0.03 higher the refractive index of the bulk silicone hydrogel material, wherein the sum of the amounts of components (a) and (b) is at least 55% by weight, wherein the bulk silicone hydrogel material includes (i) about 35% to about 80% by weight of repeating units of at least one polysiloxane vinylic crosslinker having a number average molecular weight of at least 4000 Daltons, (ii) about 18% to about 50% by weight of repeating units of at least one hydrophilic vinylic monomer, and (iii) about 15% by weight or less of repeating units of at least one polymerizable component selected from silicone-containing vinylic monomer, a non-silicone hydrophobic vinylic monomer, a non-silicone vinylic crosslinker, at least one UV-absorbing vinylic monomer, at least one HEVL-absorbing vinylic monomer, a visibility tinting agent, and combinations thereof, wherein the bulk silicone hydrogel material in fully hydrated state has an equilibrium water content of about 20% to about 60% by weight, an oxygen permeability of at least 40 barrers, and a modulus (i.e., Young's modulus) of about 1.5 MPa or less, wherein the embedded diffractive silicone hydrogel contact lens that is free of delamination and free of distortion and/or defects at the interface between the diffractive insert and the silicone hydrogel material when inspecting a microscopic image of a lens cross section of the embedded diffractive silicone hydrogel contact lens.

In some embodiments, a method for producing coated embedded contact lenses each lens body of which includes a silicone hydrogel material and an insert including a crosslinked silicone-rich material and is embedded partially within the silicone hydrogel material. When an insert is made of a silicone-rich material, it is very difficult to form a durable coating on the surfaces of the insert. Consequently, when an embedded contact lens includes an insert that is made of a silicone-rich material and is partially embedded within a silicone hydrogel material (i.e., one of its two surfaces is an integral part of the anterior or posterior surface of the embedded contact lens while the other is buried inside the silicone hydrogel material), no durable hydrogel coating can be formed to completely cover both the anterior and posterior surfaces of the embedded contact lens. However, by treating first the lens surface including the exposed surface of an insert partially embedded within a silicone hydrogel material of an embedded contact lens with a plasma or a UVC light, one can apply a durable hydrogel coating on the surface including the exposed insert surface of the embedded contact lens) according to the coating procedures disclosed in U.S. Pat. Nos. 8,529,057 and 10,449,740. A process of treating the surface including the exposed insert surface and known coating processes can be easily implemented in an automatic product line for producing coated embedded contact lenses in mass.

In at last one embodiments, a method for producing coated embedded contact lenses includes the processes of: (1) obtaining a preformed embedded contact lens that includes an anterior surface, an opposite posterior surface, a bulk silicone hydrogel material, and an insert partially embedded in the bulk silicone hydrogel material, where the insert includes a crosslinked silicone-containing vinyl copolymer different from the bulk silicone hydrogel material and has a convex front surface, an opposite concave back surface and a diameter up to about 10.0 mm, wherein the insert is concentric with a central axis of the lens body, wherein one of the convex front and concave back surfaces of the insert merges with the anterior or posterior surface of the lens body and is designated as exposing insert surface while the other one of the convex front and concave back surfaces of the insert is buried inside and in contact with the bulk silicone hydrogel material and is designated as buried insert surface, wherein the anterior or posterior surface including the exposed insert surface is designated as hybrid lens surface, wherein the crosslinked silicone-containing vinyl copolymer in fully hydrated state has an oxygen permeability of at least 30 barrers, wherein the crosslinked silicone-containing vinyl copolymer includes at least 55% by weight of repeating units of at least one silicone-containing aryl-containing polymerizable component which includes at least one silicone-containing aryl vinylic monomer and/or at least one silicone-containing aryl vinylic crosslinker, wherein the repeating units of said at least one silicone-containing aryl vinylic monomer and the repeating units of said at least one silicone-containing aryl vinylic crosslinker independent of each other are present in an amount of about 24.5% to about 75.0% by weight, wherein the bulk silicone hydrogel material includes (i) repeating units of at least one polysiloxane vinylic crosslinker and/or at least one silicone-containing vinylic monomer, (ii) repeating units of at least one hydrophilic vinylic monomer, and (iii) repeating units of at least one component selected from a non-silicone vinylic crosslinker, a non-silicone hydrophobic vinylic monomer, a UV-absorbing vinylic monomer, a HEVL-absorbing vinylic monomer, and combinations thereof, wherein the bulk silicone hydrogel material in fully hydrated state has an equilibrium water content of about 20% to about 60% by weight, an oxygen permeability of at least 40 barrers, and a modulus (i.e., Young's modulus) of about 1.5 MPa or less; (2) treating the hybrid lens surface with a UVC light or a plasma to generate reactive moieties on the hybrid lens surface; and (3) contacting the embedded contact lens having the reactive moieties thereon obtained in process (2) with a coating solution containing at least one first polymeric material having carboxylic acid groups or thiol groups to form a coated embedded contact lens having a first coating thereon, wherein the first coating includes one first layer of said at least one first polymeric material covalently attached onto the hybrid lens surface of the preformed embedded contact lens through linkages each formed between one of the reactive moieties and one carboxylic acid or thiol group.

In some embodiments, a coated embedded contact lens includes a lens body and a coating thereon, wherein the lens body includes: an anterior surface, an opposite posterior surface, a bulk silicone hydrogel material, and an insert partially embedded in the bulk silicone hydrogel material, wherein the bulk silicone hydrogel material includes (i) repeating units of at least one polysiloxane vinylic crosslinker and/or at least one silicone-containing vinylic monomer, (ii) repeating units of at least one hydrophilic vinylic monomer, and (iii) repeating units of at least one component selected from a non-silicone vinylic crosslinker, a non-silicone hydrophobic vinylic monomer, a UV-absorbing vinylic monomer, a HEVL-absorbing vinylic monomer, and combinations thereof, wherein the bulk silicone hydrogel material in fully hydrated state has an equilibrium water content of about 20% to about 60% by weight, an oxygen permeability of at least 40 barrers, and a modulus (e.g., Young's modulus) of about 1.5 MPa or less, wherein the insert includes a crosslinked silicone-containing vinyl copolymer different from the bulk silicone hydrogel material, wherein the crosslinked silicone-containing vinyl copolymer includes at least 55% by weight of repeating units of at least one silicone-containing aryl-containing polymerizable component which includes at least one silicone-containing aryl vinylic monomer and/or at least one silicone-containing aryl vinylic crosslinker, wherein the repeating units of said at least one silicone-containing aryl vinylic monomer and the repeating units of said at least one silicone-containing aryl vinylic crosslinker independent of each other are present in an amount of about 24.5% to about 75.0% by weight, wherein the crosslinked silicone-containing vinyl copolymer in fully hydrated state has an oxygen permeability of at least 30 barrers, wherein the insert has a convex front surface, an opposite concave back surface and a diameter up to about 10.0 mm, wherein the insert is concentric with a central axis of the lens body, wherein one of the convex front and concave back surfaces of the insert merges with the anterior or posterior surface of the lens body and is designated as exposing insert surface while the other one of the convex front and concave back surfaces of the insert is buried inside and in contact with the bulk silicone hydrogel material and is designated as buried insert surface, wherein the anterior or posterior surface including the exposed insert surface is designated as hybrid lens surface, wherein the coating includes one anterior hydrogel layer and one posterior hydrogel layer, wherein said at least one of the anterior and posterior hydrogel layers is covalently attached onto the hybrid lens surface.

In some embodiments, a method produces embedded diffractive silicone hydrogel contact lenses each of which includes a diffractive insert includes a crosslinked silicone-rich material having a high refractive index and is embedded with a silicone hydrogel with a lower refractive index in a cost-effective manner. When a lens-forming composition includes a significant amount of at least one high molecular weight polysiloxane vinylic crosslinker as the main (predominant) hydrophobic polymerizable component for forming a silicone hydrogel material having a glass transition temperature of about 20° C. or lower, such a lens-forming composition can be used to cast-mold embedded diffractive silicone hydrogel contact lenses each of which includes a diffractive silicone-rich insert embedded within a bulk silicone hydrogel material and is not only not susceptible to delamination but also is substantially or completely free of distortion and defects at the interface between the bulk SiHy material and the diffractive insert when inspecting a microscopic image of a lens cross section of the embedded diffractive SiHy contact lens. It is believed that by using a high molecular weight polysiloxane vinylic crosslinker as the main hydrophobic polymerizable component, one can minimize the penetration of polymerizable components in a lens-forming composition during cast molding process, thereby minimizing distortion at the interface between the diffractive silicone-rich insert and the silicone hydrogel material. It is also believed that by having a low glass transition temperature, the bulk silicone hydrogel material can be more compatible with the silicone-rich material of the diffractive insert, especially during a drying process and sterilization (autoclave). One could minimize internal stress introduced during manufacturing processes at interfaces between the diffractive insert and the bulk silicone hydrogel material, thereby maintaining the fidelity of the diffractive optics structures of the embedded diffractive SiHy contact lenses.

In at least one embodiment, a method for producing embedded silicone hydrogel contact lenses includes the processes of: (1) obtaining a female lens mold half, a male insert mold half and a male lens mold half, wherein the female lens mold half has a first molding surface defining the anterior surface of a contact lens to be molded, wherein the male insert mold half has a second molding surface defining the back surface of an insert to be molded and a diffractive optics structure thereon, wherein the male lens mold half has a third molding surface defining the posterior surface of the contact lens to be molded, wherein the male insert mold half and the female lens mold half are configured to receive each other such that an insert-molding cavity is formed between the second molding surface and a central portion of the first molding surface when the female lens mold half is closed with the male insert mold half, wherein the male lens mold half and the female lens mold half are configured to receive each other such that a lens-molding cavity is formed between the first and third molding surfaces when the female lens mold half is closed with the male lens mold half, (2) dispensing an amount of an insert-forming composition on the central portion of the first molding surface of the female lens mold half, wherein the insert-forming composition includes (i) at least one thermal free-radical initiator and (ii) about 24.5% to about 75.0% by weight of at least one silicone-containing aryl vinylic monomer and/or about 24.5% to about 75.0% by weight of at least one silicone-containing aryl vinylic crosslinker, relative to the total weight of all polymerizable components in the insert-forming composition, wherein the sum of the amounts of said at least one polysiloxane vinylic crosslinker and said at least one silicone-containing vinylic monomer is at least 55% by weight; (3) placing the male insert mold half on top of the insert-forming composition in the female lens mold half and closing the male insert mold half and the female lens mold half to form a first molding assembly including the insert-forming composition within the insert-molding cavity; (4) thermally curing the insert-forming composition in the insert-molding cavity of the first molding assembly to form a diffractive insert includes a crosslinked silicone-containing vinyl copolymer having an oxygen permeability of at least 30 barrers and a first refractive index in fully hydrated state, wherein the diffractive insert includes a diffractive optics structure created on the back surface of the diffractive insert; (5) separating the first molding assembly obtained in process (4) into the male insert mold half and the female lens mold half with the diffractive insert that is adhered onto the central portion of the first molding surface; (6) dispensing a lens-forming composition in the female lens mold half with the diffractive insert adhered thereon in an amount sufficient for filling the lens-molding cavity, wherein the lens-forming composition includes (i) at least one free-radical photoinitiator and (ii) at least one polysiloxane vinylic crosslinker having a number average molecular weight of at least 4000 Daltons in an amount of about 45% to about 80% by weight relative to the total amount of all polymerizable components in the lens-forming composition and is capable of forming a silicone hydrogel material having a glass transition temperature of about 20° C. or lower and a second refractive index in fully hydrated state, wherein the first refractive index is at least 0.03 higher than the second refractive index; (7) placing the male lens mold half on top of the lens-forming composition in the female lens mold half and closing the male lens mold half and the female lens mold half to form a second molding assembly including the lens-forming composition and the diffractive insert immersed therein in the lens-molding cavity; (8) actinically curing the lens-forming composition with the molded insert immersed therein in the lens-molding cavity of the second molding assembly to form an embedded diffractive contact lens precursor that include the silicone hydrogel material as bulk hydrogel material and the diffractive insert embedded in the silicone hydrogel material; (9) separating the second molding assembly obtained in process (8) into the male lens mold half and the female lens mold half, with the embedded diffractive contact lens precursor adhered on a lens-adhered mold half which is one of the female and second male lens mold halves; (10) removing the embedded diffractive contact lens precursor from the lens-adhered lens mold half (such as before the embedded diffractive contact lens precursor is contact with water or other liquid); and (11) subjecting the embedded diffractive contact lens precursor to post-molding processes including one or more processes selected from extraction, hydration, surface treatment, packaging, sterilization, and combinations thereof, to obtain an embedded diffractive contact lens that is substantially or completely free of delamination and substantially or completely free of distortion and/or defects at the interface between the diffractive insert and the silicone hydrogel material when inspecting a microscopic image of a lens cross section of the embedded diffractive SiHy contact lens.

In some embodiments, a method for producing embedded silicone hydrogel contact lenses includes the processes of: (1) obtaining a female insert mold half, a male lens mold half and a female lens mold half, wherein the female insert mold half has a fourth molding surface defining the front surface of an insert to be molded and a diffractive optics structure thereon, wherein the male lens mold half has a third molding surface defining the posterior surface of a contact lens to be molded, wherein the female lens mold half has a first molding surface defining the anterior surface of the contact lens to be molded, wherein the female insert mold half and the male lens mold half are configured to receive each other such that an insert-molding cavity is formed between the fourth molding surface and a central portion of the third molding surface when the female insert mold half is closed with the male lens mold half, wherein the female lens mold half and the male lens mold half are configured to receive each other such that a lens-molding cavity is formed between the first and third molding surfaces when the second female mold half is closed with the male mold half, (2) dispensing an amount of an insert-forming composition on the fourth molding surface of the female insert mold half, wherein the insert-forming composition includes (i) at least one thermal free-radical initiator and (ii) about 24.5% to about 75.0% by weight of at least one silicone-containing aryl vinylic monomer and/or about 24.5% to about 75.0% by weight of at least one silicone-containing aryl vinylic crosslinker, relative to the total weight of all polymerizable components in the insert-forming composition, wherein the sum of the amounts of said at least one polysiloxane vinylic crosslinker and said at least one silicone-containing vinylic monomer is at least 55% by weight; (3) placing the male lens mold half on top of the insert-forming composition in the female insert mold half and closing the female insert mold half and the male lens mold half to form a first molding assembly including the insert-forming composition within the insert-molding cavity; (4) thermally curing the insert-forming composition in the insert-molding cavity of the first molding assembly to form a diffractive insert includes a crosslinked silicone-containing vinyl copolymer having an oxygen permeability of at least 30 barrers and a first refractive index in fully hydrated, wherein the diffractive insert includes a diffractive optics structure created on the front surface of the diffractive insert; (5) separating the first molding assembly obtained in process (4) into the female insert mold half and the male lens mold half with the molded insert that is adhered onto the central portion of the third molding surface; (6) dispensing a lens-forming composition in the female lens mold half in an amount sufficient for filling the lens-molding cavity, wherein the lens-forming composition includes (i) at least one free-radical photoinitiator and (ii) at least one polysiloxane vinylic crosslinker having a number average molecular weight of at least 4000 Daltons in an amount of about 45% to about 80% by weight relative to the total amount of all polymerizable components in the lens-forming composition and is capable of forming a silicone hydrogel material having a glass transition temperature of about 20° C. or lower and a second refractive index in fully hydrated state, wherein the first refractive index is at least 0.03 higher than the second refractive index; (7) placing the male lens mold half with the molded insert adhered thereon on top of the lens-forming composition in the female lens mold half and closing the female lens mold half and the male lens mold half to form a second molding assembly including the lens-forming composition and the diffractive insert immersed therein in the lens-molding cavity; (8) actinically curing the lens-forming composition with the diffractive insert immersed therein in the lens-molding cavity of the second molding assembly to form an embedded diffractive contact lens precursor that includes the silicone hydrogel material as bulk hydrogel material and the diffractive insert embedded in the silicone hydrogel material; (9) separating the second molding assembly obtained in process (8) into the female lens mold half and the male lens mold half, with the embedded diffractive contact lens precursor adhered on a lens-adhered lens mold half which is one of the male and female lens mold halves; (10) removing the embedded diffractive contact lens precursor from the lens-adhered lens mold half (such as before the embedded diffractive contact lens precursor is contacted with water or other liquid); and (11) subjecting the embedded diffractive contact lens precursor to post-molding processes including a hydration process and one or more other processes selected from extraction, surface treatment, packaging, sterilization, and combinations thereof, to obtain an embedded diffractive contact lens that is substantially or completely free of delamination and substantially or completely free of distortion and/or defects at the interface between the diffractive insert and the silicone hydrogel material when inspecting a microscopic image of a lens cross section of the embedded diffractive SiHy contact lens.

In some embodiments, an embedded diffractive silicone hydrogel contact lens includes a lens body that includes: an anterior surface; an opposite posterior surface, a bulk silicone hydrogel material; and a diffractive insert embedded in the bulk silicone hydrogel material, wherein the insert includes a crosslinked silicone-containing vinyl copolymer different from the bulk silicone hydrogel material and has a convex front surface, an opposite concave back surface and a diameter up to about 10.0 mm, wherein the insert is concentric with a central axis of the lens body, wherein one of the convex front and concave back surfaces of the diffractive insert merges with the anterior or posterior surface of the lens body and is designated as exposing surface while the other one of the convex front and concave back surfaces of the diffractive insert is buried in and in contact with the bulk silicone hydrogel material and is designated as buried surface, wherein the buried surface of the diffractive insert includes a diffractive optics structure, wherein the crosslinked silicone-containing vinyl copolymer includes (a) about 24.5% to about 75.0% by weight of repeating units of at least one silicone-containing aryl vinylic monomer and/or (b) about 24.5% to about 75.0% by weight of repeating units of at least one silicone-containing aryl vinylic crosslinker and in fully hydrated state has an oxygen permeability of at least 30 barrers and a refractive index that is at least 0.03 higher the refractive index of the bulk silicone hydrogel material, wherein the sum of the amounts of components (a) and (b) is at least 55% by weight, wherein the bulk silicone hydrogel material includes (i) about 35% to about 80% by weight of repeating units of at least one polysiloxane vinylic crosslinker having a number average molecular weight of at least 4000 Daltons, (ii) about 18% to about 50% by weight of repeating units of at least one hydrophilic vinylic monomer, and (iii) about 15% by weight or less of repeating units of at least one polymerizable component selected from silicone-containing vinylic monomer, a non-silicone hydrophobic vinylic monomer, a non-silicone vinylic crosslinker, at least one UV-absorbing vinylic monomer, at least one HEVL-absorbing vinylic monomer, a visibility tinting agent, and combinations thereof, wherein the bulk silicone hydrogel material in fully hydrated state has an equilibrium water content of about 20% to about 60% by weight, an oxygen permeability of at least 40 barrers, and a modulus (e.g., Young's modulus) of about 1.5 MPa or less, wherein the embedded diffractive silicone hydrogel contact lens that is substantially or completely free of delamination and substantially or completely free of distortion and/or defects at the interface between the diffractive insert and the silicone hydrogel material when inspecting a microscopic image of a lens cross section of the embedded diffractive silicone hydrogel contact lens.

In some embodiments, crosslinked materials utilized are rigid in dry state at room temperature (about 22° C. to about 26° C.), have a relatively high oxygen permeability and a high refractive index in fully hydrated state, and can become softer at a temperature greater than 32° C. Such materials are useful for making inserts in embedded contact lenses for correcting corneal astigmatism, presbyopia, and color blindness lenses and for imparting photochromic characteristics to the lenses. When a polymerizable composition for making inserts includes (1) at least one aryl acrylic monomer and (2) at least one vinyl-functional polysiloxane that includes at least two vinyl groups each directly attached to one silicon atom and at least 15% by mole of siloxane units each having at least one phenyl substituent, as the two main components (e.g., in combination making up at least about 70% by weight relative to the total weight of all polymerizable materials) and at least one vinylic crosslinking agent, one can obtain insert materials that have a relatively high oxygen permeability and a high refractive index and are rigid in dry state (unprocessed state) at room temperature. It is believed that by incorporating at least one recited vinyl-functional polysiloxane in a polymerizable composition for making insert materials (crosslinked polymeric materials), resultant insert materials can have a relatively high oxygen permeability and high refractive index. But, such insert materials are softer and sticky at room temperature so that there are manufacturing and handling problems associated with the softness and stickiness. For example, it would be difficult to open molds and remove cast-molded inserts from molds in unprocessed state (i.e., “dry-demolding and delensing”). However, by incorporating an aryl acrylic monomer and/or crosslinker in the polymerizable composition for making inserts, insert materials can have a higher glass transition temperature (e.g., greater than 32° C.) and thereby are rigid in dry state (unprocessed state) at room temperature. Because of their rigid forms in dry state at room temperature, the manufacturing and handling problems associated with the softness and stickiness of an insert material can be significantly reduced or eliminated.

In addition, by adding two different initiators (e.g., one thermal polymerization initiator such as Vazo-64 and one peroxide initiator such as ter-butylperoxide 2-ethylhexyl carbonate) into such a polymerizable composition, two types of polymerizations can be used in curing the polymerizable composition in forming inserts. For example, the first type of polymerization (curing) is free-radical chain polymerization initiated by the thermal polymerization initiator (Vazo-64) at a temperature lower than 100° C. The other type of polymerization (curing) is peroxide activated cure system at higher temperature (e.g., 120° C.), which involves peroxide-induced free radical coupling between one vinyl and one methyl group of a siloxane unit. One can obtain an insert material having a desired set of properties, such as, oxygen permeability, refractive index, and elastic modulus, suitable for embedded contact lenses for different applications. The performances of the embedded contact lenses can be optimized for a given application.

In some embodiments, an insert for being embedded in a silicone hydrogel contact lens, including a crosslinked polymeric material, includes: (1) repeating units of said at least one vinyl-functional polysiloxane that includes at least two vinyl groups each directly attached to one silicon atom and at least 15% by mole of siloxane units each having at least one phenyl substituent; (2) repeating units of at least one aryl acrylic monomer; and (3) repeating units of at least one vinylic crosslinking agent, wherein the sum of the amounts of components (1) and (2) is at least about 70% by weight (such as about 75% to about 99% by weight, such as about 80% to about 98% by weight, such as about 85% to 98% by weight) relative to the total weight of the crosslinked polymeric material, wherein the crosslinked polymeric material in dry state has a glass transition temperature of greater than about 28° C. (such as about 30° C. or higher, such as about 32° C. or higher), wherein the crosslinked polymeric material has a water content of less than about 5% by weight (such as about 4% by weight or less, such as about 3% by weight or less, such as about 2% by weight or less), an oxygen permeability of at least about 40 barrers (such as least about 45 Barrers, such as at least about 50 Barrers, such as at least about 55 Barrers), and a refractive index of at least about 1.47 (such as at least about 1.49, such as at least 1.51, such as at least about 1.53).

It is understood that the weight percentages of each of the components of the crosslinked polymeric material of an insert can be obtained based on the weight percentages of its corresponding polymerizable component (material) in a polymerizable composition for making the insert. Examples of such vinyl functional polysiloxanes can include vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), or combinations thereof. For example, the vinyl-functional polysiloxane can be vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), or combinations thereof.

In some embodiments, the insert includes a crosslinked polymeric material, which includes: (1) repeating units of at least one vinyl-functional polysiloxane that includes at least two vinyl groups each directly attached to one silicon atom and at least 15% by mole of siloxane units each having at least one phenyl substituent; (2) repeating units of at least one aryl acrylic monomer; and (3) repeating units of at least one vinylic crosslinking agent, wherein the sum of the amounts of components (1) and (2) are at least about 70% by weight relative to the total weight of the crosslinked polymeric material, wherein the crosslinked polymeric material in dry state has a glass transition temperature of greater than about 30° C., wherein the crosslinked polymeric material has a water content of less than about 5% by weight, an oxygen permeability of at least about 40 barrers, and a refractive index of at least about 1.47.

### EMBODIMENTS

The present disclosure is further directed to the following embodiments which may be combined with any embodiments described herein.
Clause 1. An optical device, comprising:
   a bulk silicone hydrogel material having a convex anterior surface and an opposite concave posterior surface, a central optical zone, and one or more peripheral zones circumscribing the central optical zone; and
   an insert embedded in the bulk silicone hydrogel material having a convex anterior surface and an opposite concave posterior surface, the convex anterior surface comprising 10 or more echelettes,
wherein:
   the optical device having a convex anterior surface and an opposite concave posterior surface,
   the insert comprises a crosslinked silicone-containing vinyl copolymer different from a crosslinked silicone-containing vinyl copolymer of the bulk silicone hydrogel material and has a diameter up to about 10 mm,
   the insert is concentric with a central axis of the optical device,
   the convex anterior surface of the insert is embedded in and in contact with the bulk silicone hydrogel material,
   the crosslinked silicone-containing vinyl copolymer comprising (a) repeating units of a silicone-containing aryl vinylic monomer, (b) repeating units of a silicone-containing aryl vinylic crosslinker, or (c) combinations thereof, wherein the sum of the amounts of components (a) and (b) is at least 55% by weight of the crosslinked silicone-containing vinyl copolymer, and
   the bulk silicone hydrogel material comprises (i) repeating units of a polysiloxane vinylic crosslinker, (ii) repeating units of a hydrophilic vinylic monomer, and (iii) repeating units of a polymerizable component selected from the group consisting of a silicone-containing vinylic monomer, a non-silicone hydrophobic vinylic monomer, a non-silicone vinylic crosslinker, a ultraviolet (UV)-absorbing vinylic monomer, a high energy violet light (HEVL)-absorbing vinylic monomer, a visibility tinting agent, and combinations thereof.
Clause 2. The optical device of Clause 1, wherein each of the one or more peripheral zones has a dioptric power different than a dioptric power of the central optical zone.
Clause 3. The optical device of Clauses 1 or 2, wherein each of the 10 or more echelettes independently has a step height of about 8 μm to about 20 μm, such as about 8 μm to about 12 μm, alternatively about 12 μm to about 18 μm, such as about 12 μm to about 16 μm.
Clause 4. The optical device of any of Clauses 1 to 3, wherein the step heights of the 10 or more echelettes are arranged such that the step heights are substantially uniform from a central portion of the insert toward a periphery of the insert.
Clause 5. The optical device of any of Clauses 1 to 4, wherein the 10 or more echelettes are arranged such that each echelette has an outward increasing slope toward a periphery of the insert.
Clause 6. The optical device of any of Clauses 1 to 5, wherein the insert comprises a central concave portion substantially aligned with the central optical zone of the bulk silicone hydrogel material.
Clause 7. The optical device of any of Clauses 1 to 6, wherein the optical device is configured to provide a longitudinal chromatic aberration of about 1.5 D to about 2 D, alternatively about 1 D to about 1.5 D.
Clause 8. The optical device of any of Clauses 1 to 7, wherein the optical device is configured to provide a longitudinal chromatic aberration of about 2 D to about 2.5 D.
Clause 9. The optical device of any of Clauses 1 to 8, wherein the insert has a diameter of about 6 mm to about 9 mm.
Clause 10. The optical device of any of Clauses 1 to 9, wherein the concave posterior surface of the insert is substantially aligned with the concave posterior surface of the bulk silicone hydrogel material.
Clause 11. The optical device of any of Clauses 1 to 10, wherein the convex anterior surface of the insert comprises about 22 to about 25 echelettes.
Clause 12. The optical device of any of Clauses 1 to 12, wherein the convex anterior surface of the insert comprises about 26 to about 29 echelettes.
Clause 13. The optical device of any of Clauses 1 to 12, wherein the convex anterior surface of the insert comprises about 30 to about 40 echelettes.
Clause 14. The optical device of any of Clauses 1 to 13, wherein the insert has a dioptric power of about −0.5 D to about −6 D.
Clause 15. The optical device of any of Clauses 1 to 14, wherein the bulk silicone hydrogel material in the central optical zone has a dioptric power of about −8 D to about 8 D, such as about −1 D to about 1 D.
Clause 16. The optical device of any of Clauses 1 to 15, wherein the bulk silicone hydrogel material in a peripheral zone of the one or more peripheral zones has a dioptric power of about 0.5 D to about 5 D.
Clause 17. The optical device of any of Clauses 1 to 16, wherein the optical device at the central axis of the optical device has a dioptric power of about −10 D to about 6 D, such as about −1 to about 1.
Clause 18. The optical device of any of Clauses 1 to 17, wherein the bulk silicone hydrogel material comprises about 35% to about 80% by weight of repeating units of the polysiloxane vinylic crosslinker, the polysiloxane vinylic crosslinker having a number average molecular weight of at least 4000 Daltons.
Clause 19. The optical device of any of Clauses 1 to 18, wherein the crosslinked silicone-containing vinyl copolymer comprises (a) about 24.5% to about 75% by weight of repeating units of at least one silicone-containing aryl vinylic monomer, (b) about 24.5% to about 75% by weight of repeating units of at least one silicone-containing aryl vinylic crosslinker, or (c) combinations thereof, wherein the sum of the amounts of components (a) and (b) is at least 55% by weight.
Clause 20. The optical device of any of Clauses 1 to 19, wherein the bulk silicone hydrogel material comprises about 20% to about 50% by weight of repeating units of the hydrophilic vinylic monomer.
Clause 21. A method for producing a contact lens, comprising:
   (1) obtaining a female insert mold half, a male lens mold half, and a female lens mold half, wherein the female insert mold half has a first molding surface defining an anterior surface of an insert to be molded and configured to provide 10 or more echelettes for an anterior surface of the insert, wherein the male lens mold half has a second molding surface defining a posterior surface of the contact lens to be molded, wherein the female lens mold half has a third molding surface defining an anterior surface of the contact lens to be molded, wherein the female insert mold half and the male lens mold half are configured to receive each other such that an insert-molding cavity is formed between the first molding surface and a central portion of the second molding surface when the female insert mold half is closed with the male lens mold half, wherein the female lens mold half and the male lens mold half are configured to receive each other such that a lens-molding cavity is formed between the third and second molding surfaces when the female lens mold half is closed with the male mold half;
   (2) dispensing an amount of an insert-forming composition on the first molding surface of the female insert mold half, wherein the insert-forming composition comprises (i) at least one thermal free-radical initiator and (ii) (a) about 24.5% to about 75% by weight of at least one silicone-containing aryl vinylic monomer and/or (b) about 24.5% to about 75% by weight of at least one silicone-containing aryl vinylic crosslinker, relative to the total weight of all polymerizable components in the insert-forming composition, wherein the sum of the amounts of components (a) and (b) is at least 55% by weight;
   (3) placing the male lens mold half on top of the insert-forming composition in the female insert mold half and closing the female insert mold half and the male lens mold half to form a first molding assembly comprising the insert-forming composition within the insert-molding cavity;
   (4) thermally curing the insert-forming composition in the insert-molding cavity of the first molding assembly to form an insert comprising a crosslinked silicone-containing vinyl copolymer, wherein the insert comprises 10 or more echelettes on an anterior surface of the insert;
   (5) separating the first molding assembly obtained in process (4) into the female insert mold half and the male lens mold half with the molded insert disposed on the central portion of the second molding surface;
   (6) dispensing a lens-forming composition in the female lens mold half in an amount sufficient for filling the lens-molding cavity, wherein the lens-forming composition comprises (i) at least one free-radical photoinitiator and (ii) at least one polysiloxane vinylic crosslinker in an amount of about 35% to about 80% by weight relative to the total amount of all polymerizable components in the lens-forming composition;
   (7) placing the male lens mold half with the molded insert disposed thereon on top of the lens-forming composition in the female lens mold half and closing the female lens mold half and the male lens mold half to form a second molding assembly comprising the lens-forming composition and the insert disposed in the lens-molding cavity;
   (8) curing the lens-forming composition with the diffractive insert disposed therein in the lens-molding cavity of the second molding assembly to form a contact lens precursor comprising the silicone hydrogel material as bulk hydrogel material and the insert embedded in the silicone hydrogel material;
   (9) separating the second molding assembly obtained in process (8) into the female lens mold half and the male lens mold half, with the contact lens precursor adhered on a lens-adhered lens mold half which is one of the male and female lens mold halves;
   (10) removing the embedded diffractive contact lens precursor from the lens-adhered lens mold half; and
   (11) subjecting the contact lens precursor to post-molding processes to obtain the contact lens.
Clause 22. The method of Clause 21, wherein the first molding surface defining the anterior surface of the insert to be molded is configured to provide a step height of about 8 μm to about 12 μm independently to each of the 10 or more echelettes for the anterior surface of the insert.
Clause 23. The method of Clauses 21 or 22, wherein the first molding surface defining the anterior surface of the insert to be molded is configured to provide step heights of the 10 or more echelettes arranged such that the step heights are substantially uniform from a central portion of the insert to be formed toward a periphery of the insert.
Clause 24. The method of any of Clauses 21 to 23, wherein the first molding surface defining the anterior surface of the insert to be molded is configured to provide the 10 or more echelettes arranged such that each echelette has an outward increasing slope toward a periphery of the insert to be formed.
Clause 25. The method of any of Clauses 21 to 24, wherein the first molding surface defining the anterior surface of the insert to be molded is configured to provide a central concave portion to the insert to be formed.
Clause 26. The method of any of Clauses 21 to 25, wherein the first molding surface defining the anterior surface of the insert to be molded is configured to provide about 22 to about 25 echelettes for the anterior surface of the insert.
Clause 27. The method of any of Clauses 21 to 26, wherein the first molding surface defining the anterior surface of the insert to be molded is configured to provide about 30 to about 35 echelettes for the anterior surface of the insert.
Clause 28. The method of any of Clauses 21 to 27, wherein the polysiloxane vinylic crosslinker is present in the lens-forming composition in an amount of about 40% to about 75% by weight relative to the total amount of all polymerizable components in the lens-forming composition.
Clause 29. The method of any of Clauses 21 to 28, wherein the polysiloxane vinylic crosslinker is present in the lens-forming composition in an amount of about 45% to about 70% by weight relative to the total amount of all polymerizable components in the lens-forming composition.
Clause 30. The method of any of Clauses 21 to 29, wherein the silicone-containing aryl vinylic crosslinker comprises a aryl-containing polysiloxane vinylic crosslinker comprising: (1) a polydiorganosiloxane segment comprising dimethylsiloxane units and aryl-containing siloxane units each having a aryl-containing substituent having up to 45 carbon atoms; and (2) (meth)acryloyl groups.
Clause 31. The method of any of Clauses 21 to 30, wherein the polydiorganosiloxane segment comprises at least 25% by mole of the aryl-containing siloxane units.
Clause 32. The method of any of Clauses 21 to 31, wherein the aryl-containing polysiloxane vinylic crosslinker has a number average molecular weight of about 2,500 to about 60,000 Daltons.

### EXAMPLES

In today's market, there are numerous optical interventions in the form of spectacles, display systems, and contact lenses that slow down the progression of myopia. Without being bound by theory, the inventors here suggest that the eye can identify the direction of chromatic defocus to regulate eye growth in children. An approach is to defocus the blue myopically while maintaining green and red at the retina/behind the retina, as well as reduce the contrast of blue. We can achieve this with diffractive optics to increase longitudinal chromatic aberration (LCA). However, due to the shape of the human eye, light going to the peripheral retina will naturally become more hyperopically defocused. And if the subject eyes are myopic, the periphery will receive light that is more hyperopic, thus reducing the desired treatment for myopia control.

Our simulation work has shown that even if the blue is myopically defocused at the center of the retina, this will not be the case at the peripheral retina. By adding a peripheral add power profile, we can address this issue and ensure that the light to the periphery is myopically defocused for blue and more on focus with red or green.

Peripheral defocus optics has shown to degrade image quality during lens wear based on existing myopia control and presbyopia control products, which are pupil dependent. Since the primary mechanism of action is targeting LCA manipulation to ensure blue is myopically defocused for blue even in the periphery, there is more flexibility with the peripheral add design to potentially reduce image quality degradation while having superior myopia control efficacy than existing products.

To summarize, and without being bound by theory, contact lenses of the present disclosure can utilize the following mechanisms of action:

1. Primary MoA—Longitudinal Chromatic Aberration (LCA) Defocus—the distance between short and long wavelengths (blue and red focal points) in the fovea/parafovea area is a control signal for eye growth and targeted by increasing LCA with diffractive optics. The aim is to ensure blue is more myopically defocused than regular contact lenses.
2. Primary MoA—Despite being limited in number, the cones in the peripheral retina can also detect LCA (defocus distance between the blue and red focal points) to control eye growth. Increased LCA with diffractive optics and peripheral add power provides that blue is myopically defocused in the periphery as well for emmetropes and low myope children.
3. Secondary MoA—Myopically defocused polychromatic light on the peripheral retina has been clinically proven to regulate eye growth (commercially available product). This might be due to either a) the overall contrast loss and/or b) the direction of defocus as the signal to control eye growth. This is a different mechanism of action as 1 or 2.

As stated previously, myopically defocused light will also reduce contrast. With blue more myopically defocused, blue contrast will be lower. Thus, listed idea is targeting both peripheral defocus theory and lower contrast theory.

Simulation shows that increased LCA degrades MTF performance minimally. And since peripheral add utilized is to improve the LCA mechanism of action, we can change the peripheral-add design to have less visual impairment while targeting higher myopia-control efficacy than existing peripheral add/scattering optics.

FIG. 1a schematically illustrates a cross-sectional view of an embedded hydrogel contact lens, according to some embodiments.

FIG. 1b schematically illustrates a cross-sectional view of an embedded hydrogel contact lens, according to some embodiments.

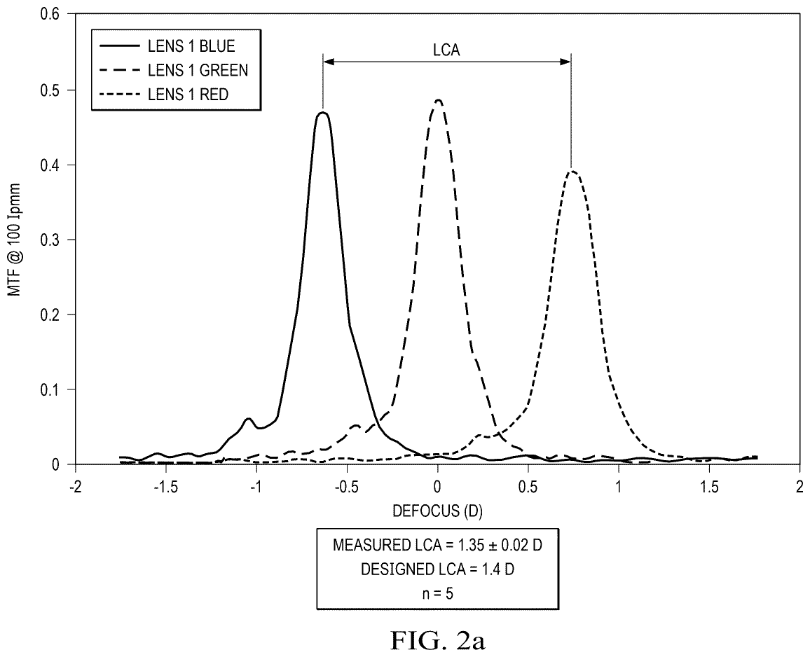

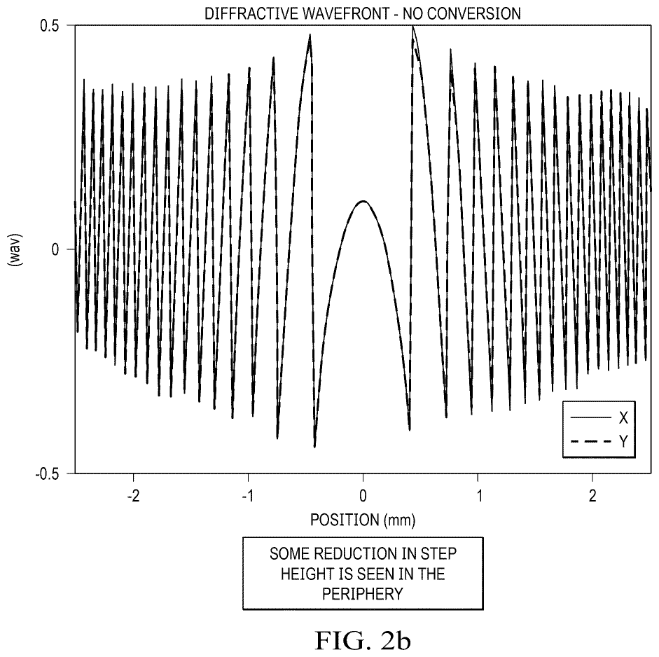

FIG. 2a is a graph illustrating measured modulation transfer function (MTF) versus defocus as a measure of longitudinal chromatic aberration of an LCA-inducing contact lens utilizing an emmetropic eye model, according to some embodiments.

FIG. 2b is a graph illustrating measured optical phase in waves versus radial coordinate of an LCA-inducing contact lens, according to some embodiments.

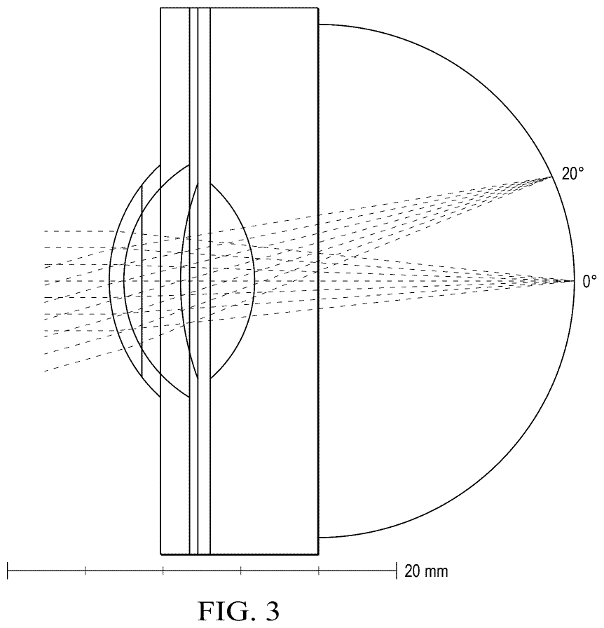

FIG. 3 is an illustration of an emmetropic optical model eye, according to some embodiments.

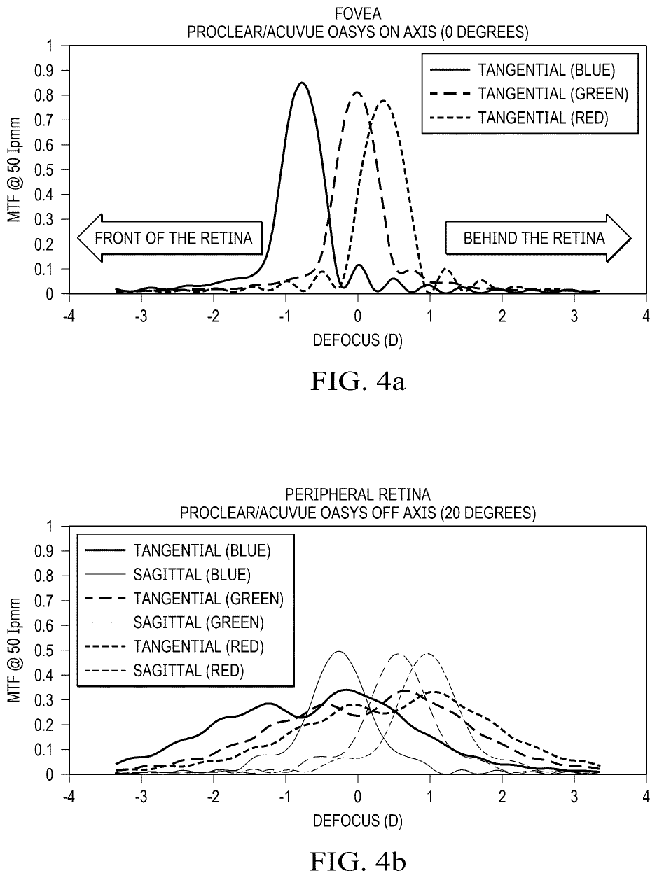

FIG. 4a is a graph illustrating MTF versus defocus at the fovea of a comparative contact lens, according to some embodiments utilizing an emmetropic eye model. FIG. 4b is a graph illustrating MTF versus defocus at the peripheral retina of a comparative contact lens utilizing an emmetropic eye model, according to some embodiments. Acuvue Oasys contact lenses are made of Senofilcon A lens material and having a water content of 38% and a Dk/t of 147×10⁻⁹. Proclear from CooperVision is made of Omafilcon A. MTF simulations for FIGS. 4 to 7 were performed with Ansys Zemax OpticStudio 2024 R2.02. Wavelengths representative of red, green, and blue were selected as 650 nm, 550 nm, and 450 nm, respectively. For 20° off axis MTF simulation, both sagittal and tangential directions were investigated. For on axis MTF simulation, sagittal and tangential MTF will be the same. Simulations in FIGS. 4 to 7 were done with 3 mm pupil size.

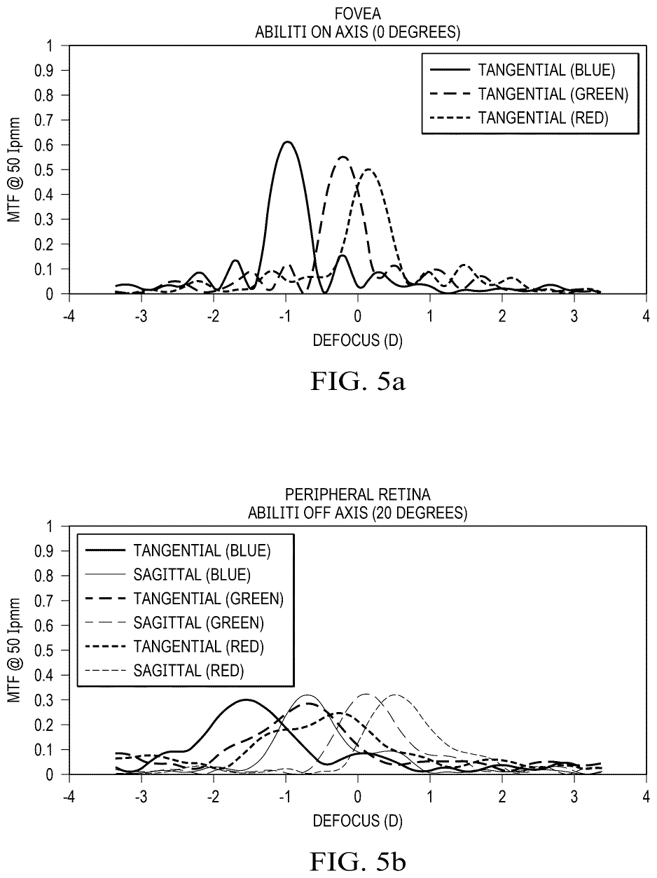

FIG. 5a is a graph illustrating MTF versus defocus at the fovea of a comparative contact lens utilizing an emmetropic eye model, according to some embodiments. FIG. 5b is a graph illustrating MTF versus defocus at the peripheral retina of a comparative contact lens utilizing an emmetropic eye model, according to some embodiments. Acuvue Abiliti contact lenses are made of Senofilcon A and have treatment zones used to reshape the cornea's curvature and focus light onto the retina. These lenses have a Dk/t value of 121×10⁻⁹.

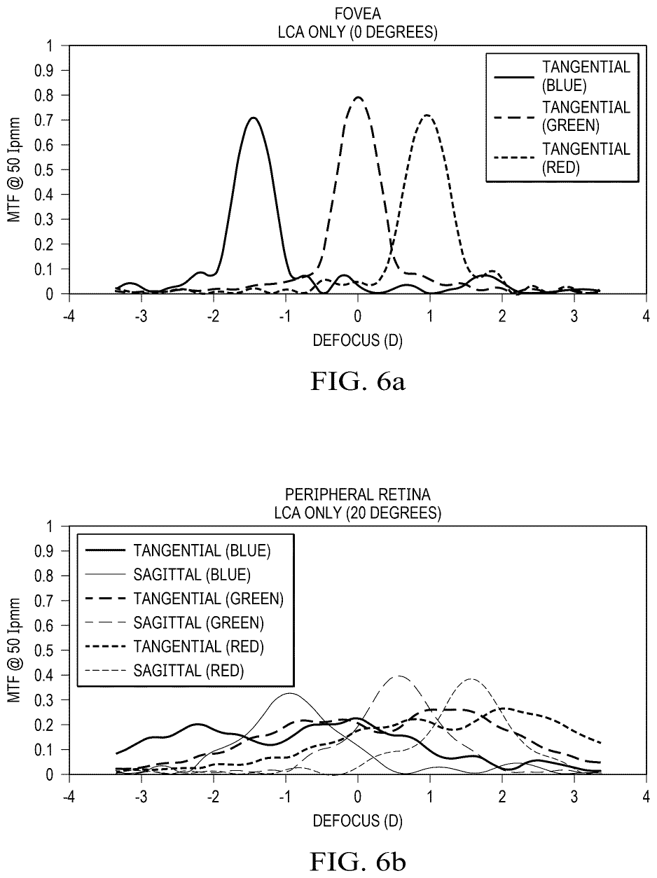

FIG. 6a is a graph illustrating MTF versus defocus at the fovea of an inventive contact lens utilizing an emmetropic eye model, according to some embodiments.

FIG. 6b is a graph illustrating MTF versus defocus at the peripheral retina of an inventive contact lens utilizing an emmetropic eye model, according to some embodiments.

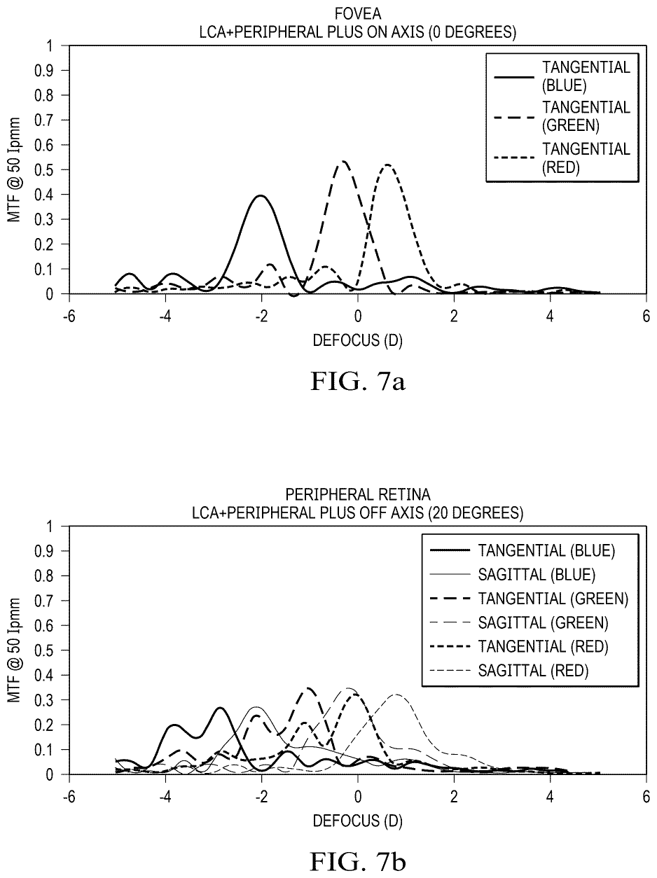

FIG. 7a is a graph illustrating MTF versus defocus at the fovea of an inventive contact lens utilizing an emmetropic eye model, according to some embodiments.

FIG. 7b is a graph illustrating MTF versus defocus at the peripheral retina of an inventive contact lens utilizing an emmetropic eye model, according to some embodiments.

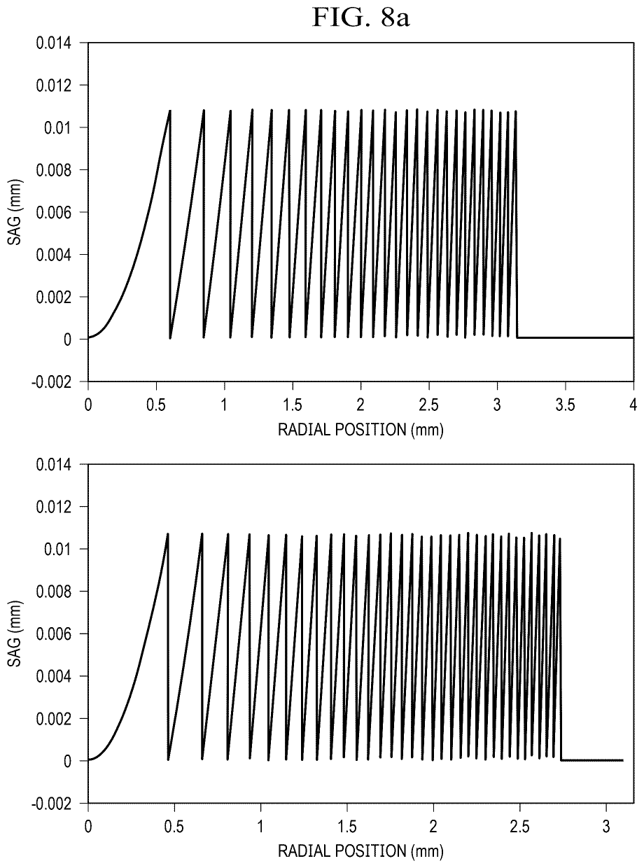

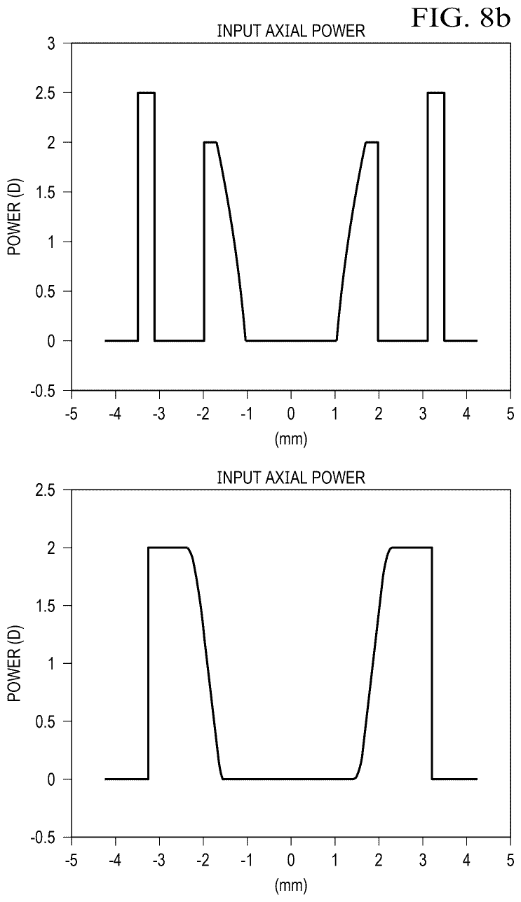

FIG. 8a shows two graphs, each illustrating a simulated diffractive profile of an inventive contact lens, according to some embodiments.

FIG. 8b shows two graphs, each illustrating input axial power of an inventive contact lens, according to some embodiments.

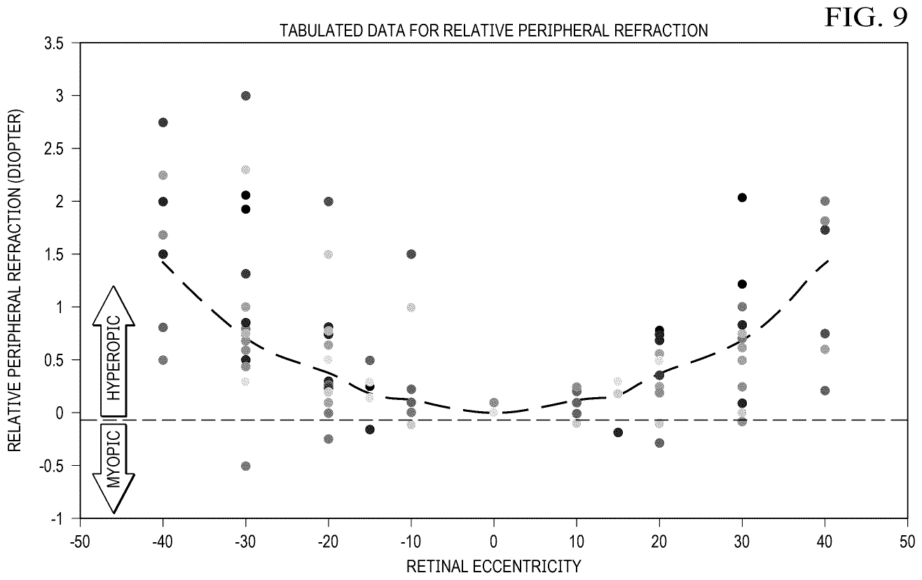

FIG. 9 is a graph illustrating a myopic eye model, according to some embodiments. The data points are based on a literature review of published relative refraction data. The model of the peripheral retina was re-defined based on available literature data for low myopes (less than −5 D). The model eye also incorporates spherical aberration of 0.9 D @5 mm pupil size. Retinal eccentricity of 10 degrees has a relative hyperopic refraction of 0.120 D, and retinal eccentricity of 20 degrees has a relative hyperopic refraction of 0.377 D.

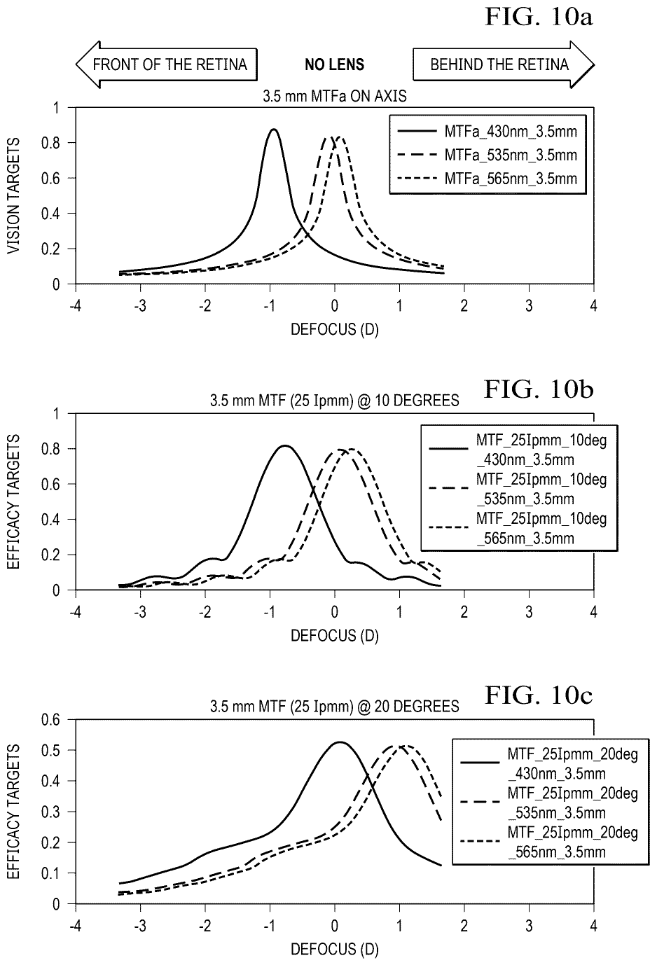

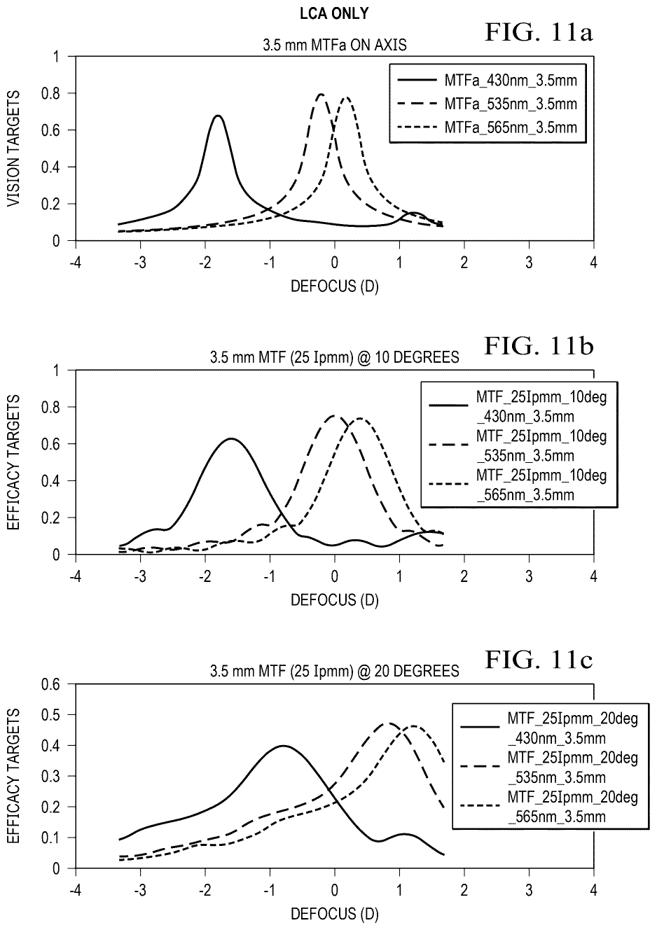

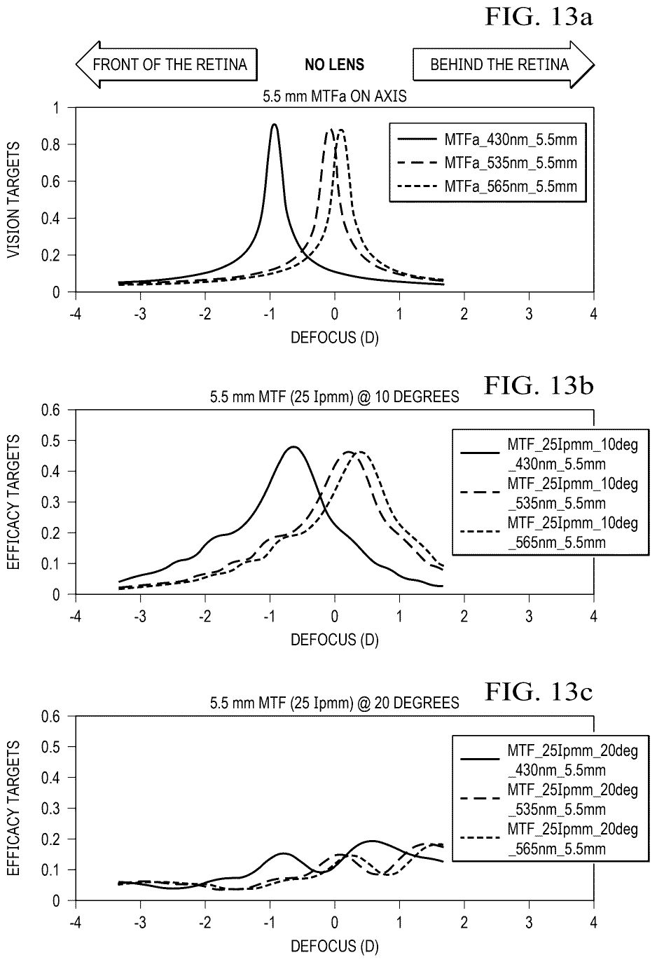

FIG. 10a is a graph illustrating MTF area under the curve (MTFa) (from 0 to 100 lp/mm) versus defocus at the fovea of an eye with no lens utilizing the myopic eye model, according to some embodiments. FIG. 10b is a graph illustrating MTF at 25 lp/mm versus defocus of an eye with no lens at 10 degrees and utilizing the myopic eye model, according to some embodiments. FIG. 10c is a graph illustrating MTF at 25 lp/mm versus defocus of an eye with no lens at 20 degrees and utilizing the myopic eye model, according to some embodiments. MTF simulations with the myopic eye model (FIGS. 10-15) were performed with Ansys Zemax OpticStudio 2024 R2.02 and assessed at multiple wavelengths. Shown wavelengths correspond with the peak cone sensitivities of L, M, and S cones of the human eye. MTFa is assessed for on-axis simulations since it corresponds with human visual acuity. MTF at 25 lp/mm is used to assess off-axis chromatic contrast which the inventors expect to be tied to efficacy. FIGS. 10-12 show simulation at 3.5 mm pupil size while FIGS. 13-15 show simulation at 5.5 mm pupil size.

FIG. 11a is a graph illustrating MTFa versus defocus at the fovea of a contact lens utilizing LCA only (no peripheral add) and utilizing the myopic eye model, according to some embodiments. FIG. 11b is a graph illustrating MTF at 25 lp/mm versus defocus of a contact lens utilizing LCA only and at 10 degrees and utilizing the myopic eye model, according to some embodiments. FIG. 11c is a graph illustrating MTF at 25 lp/mm versus defocus of a contact lens utilizing LCA only and at 20 degrees and utilizing the myopic eye model, according to some embodiments.

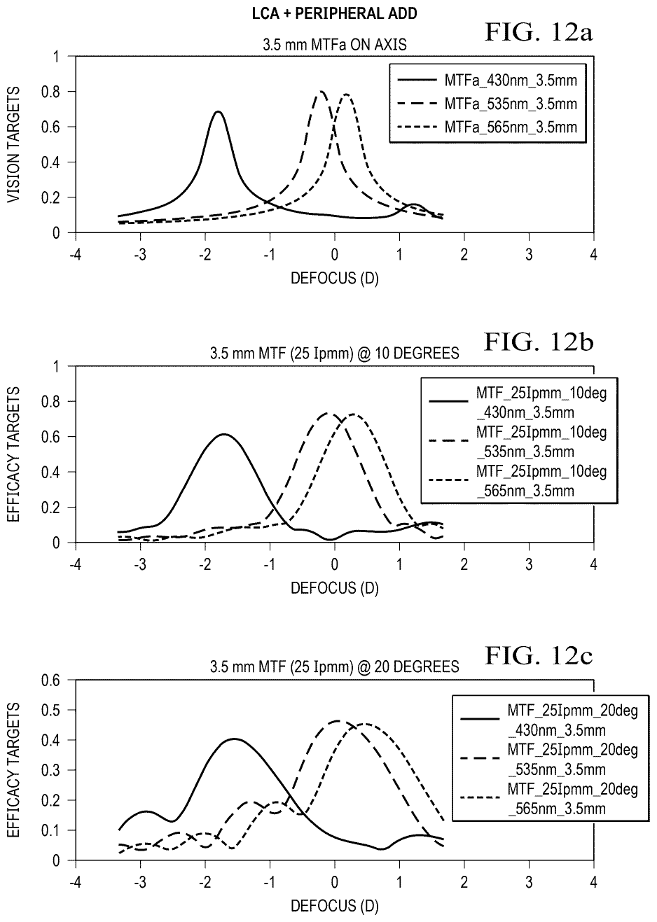

FIG. 12a is a graph illustrating MTFa versus defocus at the fovea of a contact lens utilizing LCA plus peripheral add power and utilizing the myopic eye model, according to some embodiments. FIG. 12b is a graph illustrating MTF at 25 lp/mm versus defocus of a contact lens utilizing LCA plus peripheral add power and at 10 degrees and utilizing the myopic eye model, according to some embodiments. FIG. 12c is a graph illustrating MTF at 25 lp/mm versus defocus of a contact lens utilizing LCA plus peripheral add power and at 20 degrees and utilizing the myopic eye model, according to some embodiments.

FIG. 13a is a graph illustrating MTFa versus defocus at the fovea of an eye with no lens utilizing the myopic eye model, according to some embodiments. FIG. 13b is a graph illustrating MTF at 25 lp/mm versus defocus of an eye with no lens at 10 degrees and utilizing the myopic eye model, according to some embodiments. FIG. 13c is a graph illustrating MTF at 25 lp/mm versus defocus of an eye with no lens at 20 degrees and utilizing the myopic eye model, according to some embodiments.

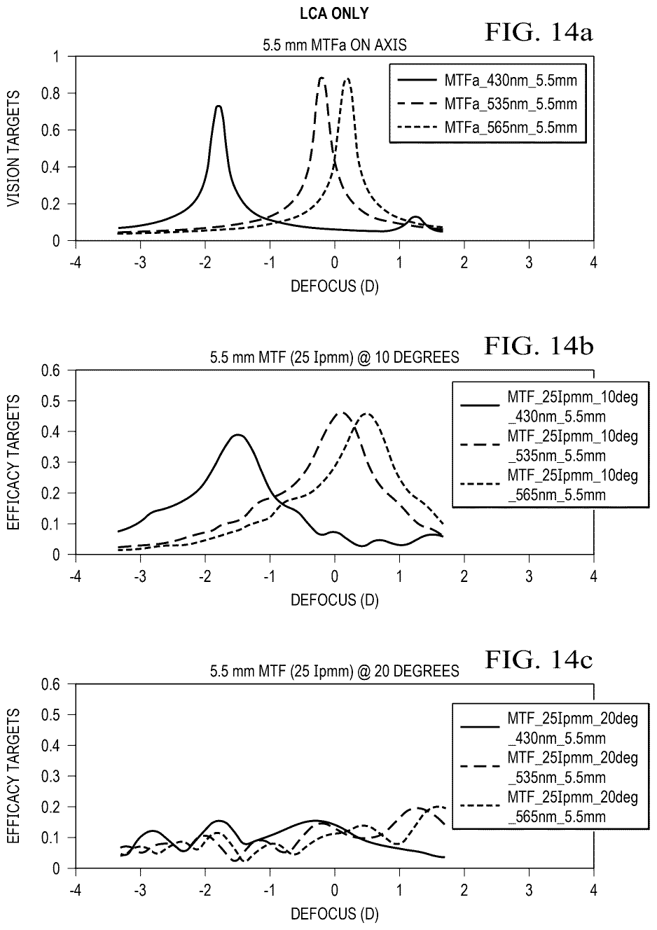

FIG. 14a is a graph illustrating MTFa versus defocus at the fovea of a contact lens utilizing LCA only (no peripheral add) and utilizing the myopic eye model, according to some embodiments. FIG. 14b is a graph illustrating MTF at 25 lp/mm versus defocus of a contact lens utilizing LCA only and at 10 degrees and utilizing the myopic eye model, according to some embodiments. FIG. 14c is a graph illustrating MTF at 25 lp/mm versus defocus of a contact lens utilizing LCA only and at 20 degrees and utilizing the myopic eye model, according to some embodiments.

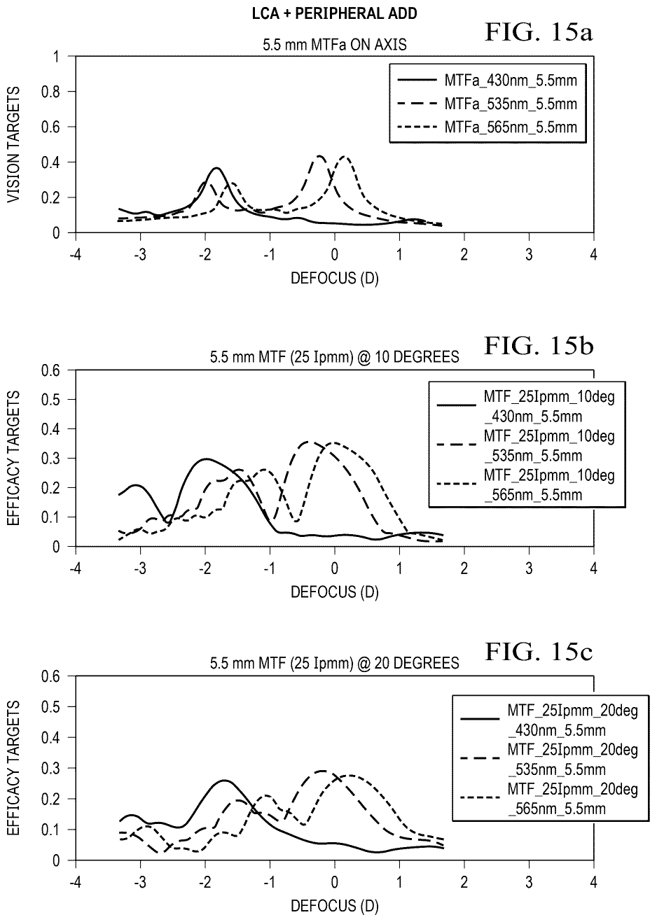

FIG. 15a is a graph illustrating MTFa versus defocus at the fovea of a contact lens utilizing LCA plus peripheral add power and utilizing the myopic eye model, according to some embodiments. FIG. 15b is a graph illustrating MTF at 25 lp/mm versus defocus of a contact lens utilizing LCA plus peripheral add power and at 10 degrees and utilizing the myopic eye model, according to some embodiments. FIG. 15c is a graph illustrating MTF at 25 lp/mm versus defocus of a contact lens utilizing LCA plus peripheral add power and at 20 degrees and utilizing the myopic eye model, according to some embodiments.

### Step Height and Peak-to-Peak Distance Measurements

Unless specified otherwise, step height and peak-to-peak measurements can be provided using laser confocal microscopy. (Keyence VK-X 3000).

### Oxygen Permeability Measurements

Unless specified, the oxygen transmissibility (Dk/t), the intrinsic (or edge-corrected) oxygen permeability (Dki or Dkc) of an insert and an insert material are determined according to procedures described in ISO 18369-4.

### Delamination

Embedded hydrogel contact lenses are examined for possible delamination either using Optimec instrument or Optical Coherence Tomography (OCT).

Regardless of evaluation method, contact lenses are staged for a minimum of 12 hours at room temperature after autoclave run and prior to delamination study.

After meeting staging time, fully hydrated contact lens is placed in a “V” graticule assembly of Optimec instrument (Model JCF; OPTIMEC England). After the contact lens is settled under the influence of gravity, the front view of the contact lens is inspected carefully for any sign of circular pattern. Delamination displays as circular patterns in Optimec image.

OCT (Spectral Domain Optical Coherence Tomography; Telesto-II; Thorlabs) could also be utilized to study delamination. OCT allows non-invasive imaging of the contact lens to obtain high resolution cross-section image. For this purpose, after meeting the minimum staging, the contact lens is removed from its blister and is soaked into PBS solution for a minimum of 30 min to come to equilibrium. Then a cuvette with a “V” block feature will be filled approximately ¾ with fresh PBS solution and the contact lens will be transferred to the cuvette using Q-tips. The lens will be allowed to freely float to the “V” shape at the bottom of the cuvette and the entire contact lens will be scanned in increment of 10 degree. Delamination appears as air pocket in interval surface of insert and carrier in OCT images.

Distortion/Defects at Insert/Bulk Lens Material interfaces

OCT (Spectral Domain Optical Coherence Tomography; Telesto-II; Thorlabs) can be utilized to study distortion of diffractive structure. OCT allows non-invasive imaging of the contact lens to obtain high resolution cross-section image. For this purpose, after sterilization cycle, the contact lens is removed from its blister and is soaked into PBS solution for a minimum of 30 min to come to equilibrium. Then a cuvette with a “V” block feature will be filled approximately ¾ with fresh PBS solution and the contact lens will be transferred to the cuvette using Q-tips. The lens will be allowed to freely float to the “V” shape at the bottom of the cuvette and the entire contact lens will be scanned in increment of 10 degree. Distortion will appear as distorted diffractive structure and surface print-through (bumps present on surface above each diffractive structure).

Another approach to characterize distortion at the interface is through using Fluorescence microscope. Briefly, the lens is soaked in a fluorescein solution overnight to enhance contrast among the different layers. High resolution 3D images of lens non-destructive cross section are obtained using a confocal fluorescence microscope using a 40× objective. Typical image size is 354×354 μm in XY direction with a resolution of 0.69 um and Z step size of 0.38 um enough to clearly resolve all the layers/structures. The lens cross section images show the various layers and also the diffractive structures at the carrier-inert interface. Distortion will appear as twisted diffractive structures at the carrier-insert interface and surface print-through (as noticeable bumps visually or through image processing on lens anterior/posterior surfaces above the diffractive structures).

### Glass Transition Temperature

The glass transition temperatures of SiHy materials are measured by differential scanning calorimetry (DSC) with modulated heating profile. The glass transition temperature of the carrier material is measured by DSC with 10° C./min ramping speed. Data are collected between −60° C. to 80° C. All material tested are unprocessed and used after the UV curing process.

Overall, contact lenses of the present disclosure have (1) a refractive anterior surface capable of providing myopic defocus and (2) an embedded monofocal diffractive insert capable of providing positive dispersion of light. The unique combination of features of contact lenses of the present disclosure slows or inhibits the progression of myopia in patients, such as children during vision development (e.g., children undergoing the visual experience-dependent critical period of vision development for adulthood). The unique combination of features of contact lenses of the present disclosure also allows a wide range of diopters (e.g., +5 D or higher) used in peripheral zone(s) of the bulk material of the lens that provide peripheral myopic defocus. Since the peripheral add power utilized is to improve a longitudinal chromatic aberration mechanism of action, the peripheral add design can be changed to have less visual impairment while targeting higher myopia-control efficacy than existing peripheral add/scattering optics. Such embodiments allow sphero-cylindrical refractive correction and independent control of chromatic aberration.

Anti-myopia benefits provided by contact lenses of the present disclosure can be realized by the lenses providing a broadened/increased longitudinal chromatic aberration of light in an eye of the user. Interestingly, the broadened/increased longitudinal chromatic aberration does not meaningfully impact on-axis image quality, depending where the peripheral add zone starts. The combination of broadened longitudinal chromatic aberration in addition to peripheral defocus gives the eye a very strong signal that the eye periphery is myopic and axial elongation of the eye will slow or stop.

In addition, manufacturing methods of lenses of the present disclosure also have scalability without a need to fully encapsulate the insert and without decreased quality of the lenses, e.g., delamination or swelling of the insert.

Unless defined otherwise, all technical and scientific terms used herein have the same meaning as commonly understood by one of ordinary skill in the art to which the present disclosure belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or an embedded lens.

A “hydrogel contact lens” refers to a contact lens including a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” interchangeably refers to a silicone-containing hydrogel obtained by copolymerization of a polymerizable composition including at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents. A polysiloxane refers to a molecule having at least one moiety of —Si—O—(Si—O)n-Si— in which each Si atom carries two organic groups as substituents and n is an integer of 2 or greater.

As used in this application, the term “non-silicone hydrogel” or “non-silicone hydrogel material” interchangeably refers to a hydrogel that is theoretically free of silicon.

An “embedded hydrogel contact lens” refers a hydrogel contact lens including at least one insert which is embedded within the bulk hydrogel material of the embedded hydrogel contact lens to an extent that at most one of the anterior or posterior surfaces of the insert can be exposed fully or partially. It is understood that the material of the insert is different from the bulk hydrogel material of the embedded hydrogel contact lens. Where the bulk hydrogel material is a silicone hydrogel, the embedded hydrogel contact lens is an embedded silicone hydrogel contact lens.

In accordance with the present disclosure, an “insert” refers to a 3-dimensional article which has a circular or annular shape having a diameter or an outer diameter on top view and is thin enough to be embedded in the bulk silicone hydrogel material of an embedded silicone hydrogel contact lens and which includes a crosslinked polymeric material (a SiHy material) that is different from the bulk silicone hydrogel material. It is understood that an insert must have a thickness less than any thickness of an embedded hydrogel contact lens in the region where the insert is embedded.

In accordance with the present disclosure, a non-hydrogel material can be any material that can absorb less than 5% (such as about 4% or less, such as about 3% or less, such as about 2% or less) by weight of water when being fully hydrated.

A “vinyl copolymer” refers to a polymer obtained by polymerizable composition including one or more vinylic monomer and optionally one or more vinylic crosslinker.

“Hydrophilic,” as used herein, describes a material or portion thereof that will more readily associate with water than with lipids.

“Hydrophobic” in reference to an insert material or insert that has an equilibrium water content (i.e., water content in fully hydrated state) of less than 5% (such as about 4% or less, such as about 3% or less, such as about 2% or less).

The term “room temperature” refers to a temperature of about 22° C. to about 26° C.

The term “soluble”, in reference to a compound or material in a solvent, means that the compound or material can be dissolved in the solvent to give a solution with a concentration of at least about 0.5% by weight at room temperature (i.e., a temperature of about 22° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

As used in this application, the term “ethylenically unsaturated group” is employed herein in a broad sense and is intended to encompass any groups containing at least one >C═CH2 group. Exemplary ethylenically unsaturated groups include (meth)acryloyl

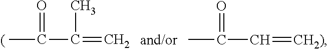

allyl, vinyl, styrenyl, or other C═CH₂ containing groups.

An “acrylic monomer” refers to a vinylic monomer having one sole (meth)acryloyl group. Examples of acrylic monomers includes (meth)acryloxy [or(meth)acryloyloxy]monomers and (meth)acrylamido monomers.

An “(meth)acryloxy monomer” or “(meth)acryloyloxy monomer” refers to a vinylic monomer having one sole group of

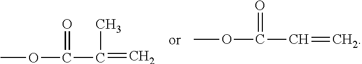

An “(meth)acrylamido monomer” refers to a vinylic monomer having one sole group of

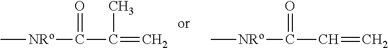

in which R^{o} is H or C₁-C₄ alkyl.

The term “aryl vinylic monomer” refers to a vinylic monomer having at least one aromatic ring.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group

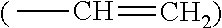

that is directly attached to the nitrogen atom of the amide group.

An “ene monomer” refers to a vinylic monomer having one sole ene group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

An “aryl vinylic crosslinker” refers to a vinylic crosslinker having at least one aromatic ring.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV/visible irradiation, ionizing radiation (e.g. gamma ray or X-ray irradiation), microwave irradiation, and the like. Thermal curing or actinic curing methods are well-known to a person skilled in the art.

As used in this application, the term “polymer” means a material formed by polymerizing/crosslinking one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy, etc. For example, the molecular weight (number average molecular weight) of a polysiloxane vinylic monomer or crosslinker is determined by ¹H NMR spectroscopy.

A “polysiloxane segment” or “polydiorganosiloxane segment” interchangeably refers to a polymer chain segment (i.e., a divalent radical) of

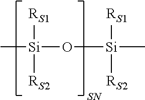

in which SN is an integer of 3 or larger and each of R_{S1} and R_{S2} independent of one another are selected from: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)γ1-OR^{o} (in which alk is C₁-C₆ alkylene diradical, R^{o} is H or C₁-C₄ alkyl and yl is an integer from 1 to 10); a C₂-C₄₀ organic radical having at least one functional group selected from hydroxyl group (—OH), carboxyl group (—COOH), amino group (—NRN¹RN^{1′}), amino linkages of —NRN¹—, amide linkages of —CONRN¹—, amide of —CONRN¹RN^{1′}, urethane linkages of —OCONH—, and C₁-C₄ alkoxy group, or a linear hydrophilic polymer chain, in which RN¹ and RN^{1′} independent of each other are hydrogen or a C₁-C₁₅ alkyl.

A “polysiloxane vinylic monomer” refers to a compound including at least one polysiloxane segment and one sole ethylenically-unsaturated group.

A “polydiorganosiloxane vinylic crosslinker” or polysiloxane vinylic crosslinker” interchangeably refers to a compound including at least one polysiloxane segment and at least two ethylenically-unsaturated groups.

A “linear polydiorganosiloxane vinylic crosslinker” or “linear polysiloxane vinylic crosslinker” interchangeably refers to a compound including a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound including at least two ethylenically-unsaturated groups and at least two polysiloxane segments each pair of which are linked by one divalent radical.

The term “fluid” as used herein indicates that a material is capable of flowing like a liquid.

As used in this application, the term “clear” in reference to a polymerizable composition means that the polymerizable composition is a transparent solution or liquid mixture (i.e., having a light transmissibility of 85% or greater, such as 90% or greater in the range between 400 to 700 nm).

The term “monovalent radical” refers to an organic radical that is obtained by removing a hydrogen atom from an organic compound and that forms one bond with one other group in an organic compound. Examples include alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogen atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl includes at least one substituent which replaces one hydrogen atom of the alkyl or the alkylenyl and is selected from hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

The intrinsic “oxygen permeability”, Dki, of a material is the rate at which oxygen will pass through a material. Oxygen permeability is conventionally expressed in units of barrers, where “barrer” is defined as [(cm³ oxygen)(mm)/(cm²)(sec)(mm Hg)]×10⁻¹⁰.

The “oxygen transmissibility”, Dk/t, of an insert or material is the rate at which oxygen will pass through a specific insert or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material.

A “precursor” refers to an insert or contact lens which is obtained by cast-molding of a polymerizable composition in a mold and has not been subjected to extraction and/or hydration post-molding processes (i.e., having not been in contact with water or any organic solvent or any liquid after molding).

A “male mold half” or “base curve mold half” interchangeably refers to a mold half having a molding surface that is a substantially convex surface and that defines the posterior surface of a contact lens or an insert.

A “female mold half” or “front curve mold half” interchangeably refers to a mold half having a molding surface that is a substantially concave surface and that defines the anterior surface of a contact lens or an insert.

The term “anterior surface”, “front surface”, “front curve surface” or “FC surface” in reference to a contact lens or an insert, as used in this application, interchangeably means a surface of the contact lens or insert that faces away from the eye during wear. The anterior surface (FC surface) is convex.

The “posterior surface”, “back surface”, “base curve surface” or “BC surface” in reference to a contact lens or insert, as used in this application, interchangeably means a surface of the contact lens or insert that faces towards the eye during wear. The posterior surface (BC surface) is concave.

A “central axis” in reference to a contact lens, as used in this application, means an imaginary reference line passing through the geometrical centers of the anterior and posterior surfaces of a contact lens.

A “central axis” in reference to a mold half, as used in this application, means an imaginary reference line passing normally (i.e., normal to the molding surface at the geometrical center) through the geometrical centers of the molding surface of the mold half.

The term “diameter” in reference to a contact lens or an insert, as used in this application, means the width of the contact lens or the insert from edge to edge.

What is claimed is:

1. An optical device, comprising:
a bulk silicone hydrogel material having a convex anterior surface and an opposite concave posterior surface, a central optical zone, and one or more peripheral zones circumscribing the central optical zone; and
an insert embedded in the bulk silicone hydrogel material having a convex anterior surface and an opposite concave posterior surface, the convex anterior surface or concave posterior surface comprising 10 or more echelettes,
wherein:
the optical device having a convex anterior surface and an opposite concave posterior surface,
the insert comprises a crosslinked silicone-containing vinyl copolymer different from a crosslinked silicone-containing vinyl copolymer of the bulk silicone hydrogel material and has a diameter up to about 10 mm,
the insert is concentric with a central axis of the optical device,
the convex anterior surface of the insert is embedded in and in contact with the bulk silicone hydrogel material,
the crosslinked silicone-containing vinyl copolymer comprising (a) repeating units of a silicone-containing aryl vinylic monomer, (b) repeating units of a silicone-containing aryl vinylic crosslinker, or (c) combinations thereof, wherein the sum of the amounts of components (a) and (b) is at least 55% by weight of the crosslinked silicone-containing vinyl copolymer, and
the bulk silicone hydrogel material comprises (i) repeating units of a polysiloxane vinylic crosslinker, (ii) repeating units of a hydrophilic vinylic monomer, and (iii) repeating units of a polymerizable component selected from the group consisting of a silicone-containing vinylic monomer, a non-silicone hydrophobic vinylic monomer, a non-silicone vinylic crosslinker, a ultraviolet (UV)-absorbing vinylic monomer, a high energy violet light (HEVL)-absorbing vinylic monomer, a visibility tinting agent, and combinations thereof.

2. The optical device of claim 1, wherein each of the one or more peripheral zones has a dioptric power different than a dioptric power of the central optical zone.

3. The optical device of claim 1, wherein each of the 10 or more echelettes independently has a step height of about 8 μm to about 20 μm.

4. The optical device of claim 3, wherein the step heights of the 10 or more echelettes are arranged such that the step heights are substantially uniform from a central portion of the insert toward a periphery of the insert.

5. The optical device of claim 1, wherein the 10 or more echelettes are arranged such that each echelette has an outward increasing slope toward a periphery of the insert.

6. The optical device of claim 1, wherein the insert comprises a central concave portion substantially aligned with the central optical zone of the bulk silicone hydrogel material.

7. The optical device of claim 1, wherein the optical device is configured to provide a longitudinal chromatic aberration of about 1.5 D to about 2 D or about 1 D to about 1.5 D.

8. The optical device of claim 1, wherein the optical device is configured to provide a longitudinal chromatic aberration of about 2 D to about 2.5 D.

9. The optical device of claim 1, wherein the insert has a diameter of about 6 mm to about 9 mm.

10. The optical device of claim 1, wherein the concave posterior surface of the insert is substantially aligned with the concave posterior surface of the bulk silicone hydrogel material.

11. The optical device of claim 1, wherein the convex anterior surface of the insert comprises about 22 to about 25 echelettes.

12. The optical device of claim 1, wherein the convex anterior surface of the insert comprises about 26 to about 29 echelettes.

13. The optical device of claim 1, wherein the convex anterior surface of the insert comprises about 30 to about 40 echelettes.

14. The optical device of claim 1, wherein the insert has a dioptric power of about −0.5 D to about −6 D.

15. The optical device of claim 14, wherein the bulk silicone hydrogel material in the central optical zone has a dioptric power of about −1 D to about 1 D.

16. The optical device of claim 15, wherein the bulk silicone hydrogel material in a peripheral zone of the one or more peripheral zones has a dioptric power of about 0.5 D to about 5 D.

17. The optical device of claim 1, wherein the optical device at the central axis of the optical device has a dioptric power of about −1 to about 1.

18. The optical device of claim 1, wherein the bulk silicone hydrogel material comprises about 35% to about 80% by weight of repeating units of the polysiloxane vinylic crosslinker, the polysiloxane vinylic crosslinker having a number average molecular weight of at least 4000 Daltons.

19. The optical device of claim 1, wherein the crosslinked silicone-containing vinyl copolymer comprises (a) about 24.5% to about 75% by weight of repeating units of at least one silicone-containing aryl vinylic monomer, (b) about 24.5% to about 75% by weight of repeating units of at least one silicone-containing aryl vinylic crosslinker, or (c) combinations thereof, wherein the sum of the amounts of components (a) and (b) is at least 55% by weight.

20. The optical device of claim 1, wherein the bulk silicone hydrogel material comprises about 20% to about 50% by weight of repeating units of the hydrophilic vinylic monomer.

21. A contact lens comprising:
a bulk silicone hydrogel material having a convex anterior surface and an opposite concave posterior surface, a central optical zone, and one or more peripheral zones circumscribing the central optical zone; and
an insert embedded in the bulk silicone hydrogel material having a convex anterior surface and an opposite concave posterior surface, the insert being concentric with a central axis of the optical device;
the contact lens configured to provide a longitudinal chromatic aberration of about 1 D to about 2.5 D.

22. The contact lens of claim 21, wherein the convex anterior surface of the insert or the concave posterior surface of the insert comprising 10 or more echelettes.

23. The contact lens of claim 21, wherein each of the one or more peripheral zones has a dioptric power different than a dioptric power of the central optical zone.

24. The contact lens of claim 22, wherein each of the 10 or more echelettes independently has a step height of about 8 μm to about 20 μm.

25. The contact lens of claim 24, wherein the step heights of the 10 or more echelettes are arranged such that the step heights are substantially uniform from a central portion of the insert toward a periphery of the insert.

26. The contact lens of claim 22, wherein the 10 or more echelettes are arranged such that each echelette has an outward increasing slope toward a periphery of the insert.

27. The contact lens of claim 21, wherein the optical device is configured to provide a longitudinal chromatic aberration of about 1.5 D to about 2 D.

28. The contact lens of claim 21, wherein the optical device is configured to provide a longitudinal chromatic aberration of about 2 D to about 2.5 D.

29. The contact lens of claim 22, wherein the convex anterior surface of the insert comprises about 22 to about 30 echelettes.
